(19) United States
(12) Patent Application Publication
(10) Pub. No.: US 2025/0030046 A1
(43) Pub. Date: Jan. 23, 2025

(54) SOLID ELECTROLYTE COMPOSITION, ELECTRODE COMPOSITION, METHOD FOR PRODUCING SOLID ELECTROLYTE SHEET, METHOD FOR PRODUCING ELECTRODE SHEET, AND METHOD FOR PRODUCING BATTERY

(71) Applicant: Panasonic Intellectual Property Management Co., Ltd., Osaka (JP)

(72) Inventor: TATSUYA OSHIMA, Osaka (JP)

(21) Appl. No.: 18/905,147

(22) Filed: Oct. 3, 2024

Related U.S. Application Data
(63) Continuation of application No. PCT/JP2022/038378, filed on Oct. 14, 2022.

(30) Foreign Application Priority Data
Apr. 15, 2022 (JP) 2022-067960

(51) Int. Cl. H01M 10/0562; H01M 4/04; H01M 10/058

(52) U.S. Cl. CPC H01M 10/0562; H01M 4/0407; H01M 10/058; H01M 2300/008

(57) ABSTRACT

A solid electrolyte composition according to the present disclosure contains a solvent and an ionic conductor containing a solid electrolyte and a binder and dispersed in the solvent, wherein the binder contains a styrene elastomer, and the styrene elastomer has a total nitrogen content of 30 ppm or more and 130 ppm or less.

### BACKGROUND

### 1. Technical Field

The present disclosure relates to a solid electrolyte composition, an electrode composition, a method for producing a solid electrolyte sheet, a method for producing an electrode sheet, and a method for producing a battery.

### 2. Description of the Related Art

International Publication No. WO 2021/187270 describes a solid electrolyte composition containing a binder. International Publication No. WO 2021/187270 describes a binder for an all-solid-state secondary battery containing a polymer having a unit based on a modifying agent having at least one type of atom selected from the group consisting of a nitrogen atom, an oxygen atom, a silicon atom, a germanium atom, and a tin atom.

### SUMMARY

One non-limiting and exemplary embodiment provides a solid electrolyte composition suitable for improving the dispersibility of a solid electrolyte.

In one general aspect, the techniques disclosed here feature a solid electrolyte composition that contains a solvent and an ionic conductor containing a solid electrolyte and a binder and dispersed in the solvent, wherein the binder contains a styrene elastomer, and the styrene elastomer has a total nitrogen content of 30 ppm or more and 130 ppm or less.

The present disclosure can provide a solid electrolyte composition suitable for improving the dispersibility of a solid electrolyte.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view of a solid electrolyte composition according to a first embodiment;

FIG. 2 is a schematic view of an electrode composition according to a second embodiment;

FIG. 3 is a flowchart of a method for producing a solid electrolyte sheet according to a third embodiment;

FIG. 4 is a cross-sectional view of an electrode assembly according to the third embodiment;

FIG. 5 is a cross-sectional view of a transfer sheet according to the third embodiment;

FIG. 6 is a cross-sectional view of an electrode according to a fourth embodiment;

FIG. 7 is a cross-sectional view of an electrode transfer sheet according to the fourth embodiment;

FIG. 8 is a cross-sectional view of a battery precursor according to the fourth embodiment;

FIG. 9 is a cross-sectional view of a battery according to a fifth embodiment; and

FIG. 10 is a graph of the ratio of a component 1 determined by pulsed NMR measurement with respect to the total nitrogen content of a styrene elastomer in Examples and Comparative Examples.

### DETAILED DESCRIPTIONS

### (Underlying Knowledge Forming Basis of the Present Disclosure)

In the field of known secondary batteries, an organic electrolyte solution produced by dissolving an electrolyte salt in an organic solvent is mainly used. In an secondary battery containing an organic electrolyte solution, liquid leakage is a concern. It has also been pointed out that a short circuit or the like generates a large amount of heat.

On the other hand, an all-solid-state secondary battery containing an inorganic solid electrolyte instead of an organic electrolyte solution is attracting attention. An all-solid-state secondary battery does not have liquid leakage. Due to high thermal stability of an inorganic solid electrolyte, it is expected that even a short circuit or the like generates a smaller amount of heat.

To put an all-solid-state secondary battery using a solid electrolyte into practical use, it is necessary to prepare a solid electrolyte composition containing a solid electrolyte and having fluidity. As for an electrode composition, it is also necessary to prepare an electrode composition containing a solid electrolyte and having fluidity. For example, a solid electrolyte composition with fluidity can be used to apply the solid electrolyte composition to the surface of an electrode to form a solid electrolyte sheet. For example, an electrode composition with fluidity can be used to apply the electrode composition to the surface of a current collector to form an electrode sheet. In the production of a solid electrolyte sheet and an electrode sheet, a solid electrolyte composition or an electrode composition can be used for production by wet coating. Wet coating is superior to dry coating in terms of the uniformity of a coating film and mass productivity.

On the other hand, unlike general ceramic particles, for example, titanium oxide particles, a solid electrolyte is sensitive to the polarity of a solvent and the polarity of a binder. More specifically, when a solvent having a polar substituent, such as a carbonyl group, is used, the solvent is excessively adsorbed to solid electrolyte particles or reacts with solid electrolyte particles. A similar phenomenon can occur for a binder. This may decrease the ionic conductivity of the solid electrolyte and may result in a battery with a lower energy density and lower cycle performance. Thus, to prepare a solid electrolyte composition, it is necessary to use a solvent with relatively low polarity and a binder with relatively low polarity. A solvent with low polarity is, for example, an aromatic hydrocarbon. A binder with low polarity is, for example, a styrene elastomer. When a solvent with low polarity and a binder with low polarity are used, however, the interaction between solid electrolyte particles acts more strongly. Thus, the use of a solvent with low polarity and a binder with low polarity may reduce the dispersibility of solid electrolyte particles. Thus, to produce a solid electrolyte sheet using a solvent with low polarity and a binder with low polarity, a technique for improving the dispersibility of a solid electrolyte in a solid electrolyte composition is required.

The present inventor has studied a solid electrolyte composition containing a solid electrolyte and a binder. As a result, the present inventor has found a problem that the dispersibility of a solid electrolyte decreases in a solid electrolyte composition containing a styrene elastomer with a total nitrogen content of more than 130 ppm as a binder. This problem is considered to be caused by excessive adsorption of the binder to the solid electrolyte. More specifically, a modifying group that is a functional group containing nitrogen (N), such as an amino group, can be introduced into a styrene elastomer composed mainly of carbon (C) and hydrogen (H) to impart polarity to the styrene elastomer. Consequently, it is thought that the interaction between a N atom contained in the styrene elastomer and the solid electrolyte causes adsorption. In a styrene elastomer with a total nitrogen content of more than 130 ppm, it is thought that the interaction works excessively and reveals the above problem.

In a solid electrolyte composition containing a styrene elastomer with a total nitrogen content of less than 30 ppm as a binder, a solid electrolyte has lower dispersibility. This problem is considered to be caused by insufficient adsorption of the binder to the solid electrolyte. More specifically, it is thought that the styrene elastomer with a total nitrogen content of less than 30 ppm does not interact sufficiently with the solid electrolyte and causes the above problem.

To prepare a solid electrolyte composition with appropriate fluidity, for example, it is necessary to mix a solvent with an ionic conductor containing a solid electrolyte and a binder. The present inventor prepared solid electrolyte compositions by mixing various ionic conductors and solvents and evaluated the dispersibility of a solid electrolyte in the solid electrolyte compositions. As a result, it has been found that the dispersibility of a solid electrolyte is improved in a solid electrolyte composition containing a specific binder. From this point of view, the configuration of the present disclosure has been conceived.

### Outline of One Aspect of the Present Disclosure

A solid electrolyte composition according to a first aspect of the present disclosure contains
a solvent and
an ionic conductor containing a solid electrolyte and a binder and dispersed in the solvent,
wherein the binder contains a styrene elastomer, and
the styrene elastomer has a total nitrogen content of 30 ppm or more and 130 ppm or less.

According to the first aspect, in the solid electrolyte composition, an appropriate interaction acts between the solid electrolyte and the binder. This interaction can improve the dispersibility of the solid electrolyte in the solvent.

In a second aspect of the present disclosure, for example, in the solid electrolyte composition according to the first aspect, the styrene elastomer may have a weight-average molecular weight of 200,000 or more.

According to the second aspect, particles of the solid electrolyte can adhere to each other with sufficient adhesive strength and can improve the peel strength of a solid electrolyte sheet produced using the solid electrolyte composition.

In a third aspect of the present disclosure, for example, in the solid electrolyte composition according to the first or second aspect, for example, the nitrogen ratio with respect to the polymer chain of the styrene elastomer may be 2.0 or more.

According to the third aspect, the styrene elastomer contains a predetermined amount of nitrogen. This can improve the dispersibility of the solid electrolyte even when a small amount of binder is added to the solid electrolyte composition.

In a fourth aspect of the present disclosure, for example, in the solid electrolyte composition according to any one of the first to third aspects, the styrene elastomer may include at least one selected from the group consisting of a modified styrene-ethylene/butylene-styrene block copolymer (modified SEBS) and a modified styrene-butadiene rubber (modified SBR).

According to the fourth aspect, the modified SEBS or the modified SBR has higher flexibility and elasticity and is particularly suitable as a binder for a solid electrolyte sheet.

In a fifth aspect of the present disclosure, for example, in the solid electrolyte composition according to the fourth aspect, the styrene elastomer may include a modified SBR.

According to the fifth aspect, the modified SBR tends to be more easily compressed in hot pressing than the modified SEBS. This can further improve the filling characteristics of an ionic conductor contained in a solid electrolyte sheet produced from the solid electrolyte composition.

In a sixth aspect of the present disclosure, for example, in the solid electrolyte composition according to any one of the first to fifth aspects, the solvent may have a boiling point of 100° C. or more and 250° C. or less.

According to the sixth aspect, the solvent is less likely to volatilize at normal temperature, and the solid electrolyte composition can be stably produced.

In a seventh aspect of the present disclosure, for example, in the solid electrolyte composition according to any one of the first to sixth aspects, the solvent may contain an aromatic hydrocarbon.

According to the seventh aspect, the binder tends to have high solubility in the aromatic hydrocarbon. In particular, a styrene elastomer is easily dissolved in the aromatic hydrocarbon. When the binder has high solubility in the aromatic hydrocarbon, the dispersibility of the solid electrolyte in the solid electrolyte composition can be further improved. Furthermore, due to its relatively low polarity, the aromatic hydrocarbon can reduce the decrease in ionic conductivity due to excessive adsorption to or reaction with the solid electrolyte.

In an eighth aspect of the present disclosure, for example, in the solid electrolyte composition according to the seventh aspect, the solvent may contain tetralin.

According to the eighth aspect, tetralin has a relatively high boiling point. Tetralin not only improves the dispersibility of the solid electrolyte in the solid electrolyte composition but also allows the solid electrolyte composition to be stably produced by a kneading process.

In a ninth aspect of the present disclosure, for example, in the solid electrolyte composition according to any one of the first to eighth aspects, the solid electrolyte may include a sulfide solid electrolyte.

According to the ninth aspect, the sulfide solid electrolyte is relatively soft and tends to have high filling characteristics and ionic conductivity after press forming. This can provide a battery with higher output power.

In a tenth aspect of the present disclosure, for example, in the solid electrolyte composition according to any one of the first to eighth aspects, the solid electrolyte may include a halide solid electrolyte.

According to the tenth aspect, the halide solid electrolyte does not contain sulfur and can generate less hydrogen sulfide gas.

An electrode composition according to an eleventh aspect of the present disclosure contains an active material and the solid electrolyte composition according to any one of the first to tenth aspects.

An electrode sheet produced using the electrode composition according to the eleventh aspect can have an electrode layer in which the solid electrolyte has improved dispersibility. The electrode sheet in which the solid electrolyte has improved dispersibility can have improved surface smoothness and ionic conductivity.

A method for producing a solid electrolyte sheet according to a twelfth aspect of the present disclosure includes
applying the solid electrolyte composition according to any one of the first to tenth aspects to an electrode or a base material to form a coating film and
removing the solvent from the coating film.

According to the twelfth aspect, a solid electrolyte sheet with a homogeneous and uniform thickness can be produced.

A method for producing a battery according to a thirteenth aspect of the present disclosure is a method for producing a battery including a first electrode, an electrolyte layer, and a second electrode in this order, and includes the following (i) or (ii):
(i) applying the solid electrolyte composition according to any one of the first to tenth aspects to the first electrode to form a coating film,
removing the solvent from the coating film to form an electrode assembly including the first electrode and the electrolyte layer, and
combining the electrode assembly and the second electrode such that the electrolyte layer is positioned between the first electrode and the second electrode, or
(ii) applying the solid electrolyte composition according to any one of the first to tenth aspects to a base material to form a coating film,
removing the solvent from the coating film to form the electrolyte layer, and combining the first electrode, the second electrode, and
the electrolyte layer such that the electrolyte layer is positioned between the first electrode and the second electrode.

According to the thirteenth aspect, a battery with a high energy density can be produced.

A method for producing an electrode sheet according to a fourteenth aspect of the present disclosure includes
applying the electrode composition according to the eleventh aspect to a current collector, a base material, or an electrode assembly to form a coating film and
removing the solvent from the coating film.

According to the fourteenth aspect, an electrode sheet with a homogeneous and uniform thickness can be produced.

A method for producing a battery according to a fifteenth aspect of the present disclosure is a method for producing a battery including a first electrode, an electrolyte layer, and a second electrode in this order, and includes the following (iii), (iv), or (v):
(iii) applying the electrode composition according to the eleventh aspect to a current collector to form a coating film,
removing the solvent from the coating film to form the first electrode, and
combining the first electrode, the second electrode, and the electrolyte layer such that the electrolyte layer is positioned between the first electrode and the second electrode,
(iv) applying the electrode composition according to the eleventh aspect to a base material to form a coating film,
removing the solvent from the coating film to form an electrode sheet for the first electrode, and combining the first electrode, the second electrode, and
the electrolyte layer such that the electrolyte layer is positioned between the first electrode and the second electrode, or
(v) applying the electrode composition according to the eleventh aspect to the electrolyte layer of an electrode assembly, which is a laminate of the first electrode and the electrolyte layer, to form a coating film, and
removing the solvent from the coating film to form an electrode sheet for the second electrode.

According to the fifteenth aspect, a battery with a high energy density can be produced.

A method for producing a battery according to a sixteenth aspect of the present disclosure is a method for producing a battery including a first electrode, an electrolyte layer, and a second electrode in this order, and includes (vi) or (vii):
(vi) applying the electrode composition according to the eleventh aspect to a current collector to form a first coating film,
removing the solvent from the first coating film to form the first electrode,
applying the solid electrolyte composition according to any one of the first to tenth aspects to the first electrode to form a second coating film, removing the solvent from the second coating film to form the electrolyte layer, and
combining the first electrode, the electrolyte layer, and the second electrode such that the electrolyte layer is positioned between the first electrode and the second electrode, or

(vii) applying the electrode composition according to the eleventh aspect to a first base material to form a first coating film,
removing the solvent from the first coating film to form the first electrode,
applying the solid electrolyte composition according to any one of the first to tenth aspects to a second base material to form a second coating film,
removing the solvent from the second coating film to form the electrolyte layer, and
combining the first electrode, the second electrode, and the electrolyte layer such that the electrolyte layer is positioned between the first electrode and the second electrode.

According to the sixteenth aspect, a battery with a higher energy density can be produced.

Embodiments of the present disclosure are described below with reference to the accompanying drawings. The present disclosure is not limited to these embodiments.

### First Embodiment

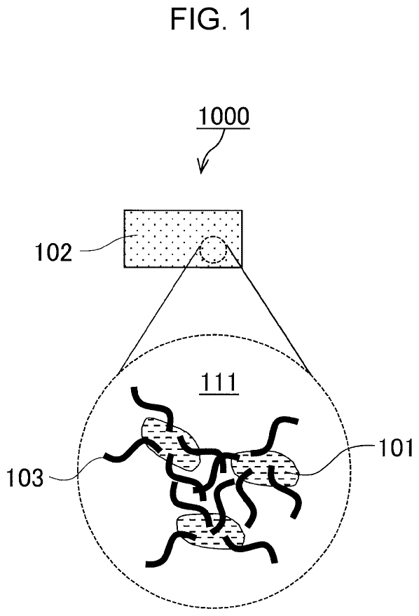

FIG. 1 is a schematic view of a solid electrolyte composition 1000 according to a first embodiment. The solid electrolyte composition 1000 contains an ionic conductor 111 and a solvent 102. The ionic conductor 111 contains a solid electrolyte 101 and a binder 103. The ionic conductor 111 is dispersed or dissolved in the solvent 102. Thus, the solid electrolyte 101 and the binder 103 are dispersed or dissolved in the solvent 102. The binder 103 contains a styrene elastomer. The styrene elastomer has a total nitrogen content of 30 ppm or more and 130 ppm or less.

The above configuration can improve the dispersibility of the solid electrolyte 101 in the solid electrolyte composition 1000. A solid electrolyte sheet produced using the solid electrolyte composition 1000 can have improved surface smoothness and ionic conductivity. A solid electrolyte sheet with improved surface smoothness and ionic conductivity can improve the energy density of a battery. The battery is, for example, an all-solid-state secondary battery.

Controlling the total nitrogen content of the styrene elastomer, more specifically, using the styrene elastomer with a total nitrogen content of 30 ppm or more and 130 ppm or less can suppress a phenomenon where the solid electrolyte has impaired dispersibility. As described above, since the solid electrolyte is a ceramic material sensitive to the polarity of the binder, it is required to appropriately control the total nitrogen content of the styrene elastomer, that is, in the order of ppm. As described above, in the solid electrolyte composition 1000, the binder 103 has a total nitrogen content of 30 ppm or more and 130 ppm or less. This can improve the dispersibility of the solid electrolyte 101 in the solid electrolyte composition 1000.

The “solid electrolyte sheet” may be a free-standing sheet member or may be a solid electrolyte layer supported by an electrode or a base material.

The solid electrolyte composition 1000 may be a fluid slurry. The solid electrolyte composition 1000 with fluidity can form a solid electrolyte sheet by a wet method, such as a coating method.

The solid electrolyte composition 1000 is described in detail below.

### [Solid Electrolyte Composition]

The solid electrolyte composition 1000 contains the ionic conductor 111 and the solvent 102. The ionic conductor 111 contains the solid electrolyte 101 and the binder 103. The solid electrolyte 101, the binder 103, the ionic conductor 111, and the solvent 102 are described in detail below.

### <Solid Electrolyte>

In the first embodiment, the solid electrolyte 101 may be a sulfide solid electrolyte, an oxide solid electrolyte, a halide solid electrolyte, a polymeric solid electrolyte, a complex hydride solid electrolyte, or the like. When the solid electrolyte 101 contains a solid electrolyte containing lithium, the resulting solid electrolyte sheet can be used to produce a lithium secondary battery. The solid electrolyte 101 may contain a sulfide solid electrolyte. The solid electrolyte 101 may be a sulfide solid electrolyte. The solid electrolyte 101 may contain a halide solid electrolyte. The solid electrolyte 101 may be a halide solid electrolyte.

The term “oxide solid electrolyte”, as used herein, refers to a solid electrolyte containing oxygen. The oxide solid electrolyte may further contain an anion other than sulfur and a halogen element as an anion other than oxygen.

The term “halide solid electrolyte”, as used herein, refers to a solid electrolyte containing a halogen element and no sulfur. The term “solid electrolyte containing no sulfur”, as used herein, refers to a solid electrolyte represented by a composition formula not containing a sulfur element. Thus, a solid electrolyte containing a trace amount of a sulfur component, for example, 0.1% by mass or less of sulfur, is included in the solid electrolyte containing no sulfur. The halide solid electrolyte may further contain oxygen as an anion other than the halogen element.

The sulfide solid electrolyte is, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or the like. LiX, Li₂O, MO_{q}, LiₚMO_{q}, or the like may be added to these. The element X in “LiX” denotes at least one selected from the group consisting of F, Cl, Br, and I. The element M in “MO_{q}” and “LiₚMO_{q}” denotes at least one selected from the group consisting of P, Si, Ge, B, Al, Ga, In, Fe, and Zn. p and q in “MO_{q}” and “LiₚMO_{q}” each independently denote a natural number.

The sulfide solid electrolyte is, for example, a Li₂S—P₂S₅ glass-ceramic. LiX, Li₂O, MO_{q}, LiₚMO_{q}, or the like may be added to the Li₂S—P₂S₅ glass-ceramic, or at least two selected from LiCl, LiBr, and LiI may be added to the Li₂S—P₂S₅ glass-ceramic. The Li₂S—P₂S₅ glass-ceramic is a relatively soft material, and a solid electrolyte sheet containing the Li₂S—P₂S₅ glass-ceramic can therefore be used to produce a battery with higher durability. In the solid electrolyte composition 1000, even when a sulfide solid electrolyte is used, the dispersibility of the solid electrolyte 101 can be more effectively improved.

The oxide solid electrolyte is, for example, a NASICON-type solid electrolyte, such as LiTi₂(PO₄)₃ or an element-substituted product thereof, a (LaLi)TiO₃ perovskite solid electrolyte, a LISICON-type solid electrolyte, such as Li₁₄ZnGe₄O₁₆, Li₄SiO₄, LiGeO₄, or an element-substituted product thereof, a garnet-type solid electrolyte, such as Li₂La₃Zr₂O₁₂ or an element-substituted product thereof, Li₃PO₄ or a N-substituted product thereof, a glass in which Li₂SO₄, Li₂CO₃, or the like is added to a base Li—B—O compound, such as LiBO₂ or Li₃BO₃, a glass-ceramic, or the like.

The halide solid electrolyte contains, for example, Li, M1, and X. M1 is at least one selected from the group consisting of metal elements other than Li and metalloid elements. X is at least one selected from the group consisting of F, Cl, Br, and I. The halide solid electrolyte has high thermal stability and can therefore improve the safety of the battery. The halide solid electrolyte does not contain sulfur and can generate less hydrogen sulfide gas.

The term “metalloid elements”, as used herein, refers to B, Si, Ge, As, Sb, and Te.

The term “metal elements”, as used herein, refers to all group 1 to 12 elements of the periodic table except hydrogen and all group 13 to 16 elements of the periodic table except B, Si, Ge, As, Sb, Te, C, N, P, O, S, and Se.

Thus, the terms “metalloid elements” and “metal elements”, as used herein, refer to a group of elements that can become a cation when forming an inorganic compound with a halogen element.

For example, the halide solid electrolyte may be a material represented by the following composition formula (1):

Li_{α}M1_{β}X_{γ} formula (1)

In the composition formula (1), a, B, and y are each independently more than 0. Y may be 4, 6, or the like.

The above configuration improves the ionic conductivity of the halide solid electrolyte and can improve the ionic conductivity of a solid electrolyte sheet formed from the solid electrolyte composition 1000. The solid electrolyte sheet used in a battery can further improve the output characteristics of the battery.

In the composition formula (1), the element M1 may include Y (=yttrium). Thus, the halide solid electrolyte may contain Y as a metal element.

The halide solid electrolyte containing Y may be represented, for example, by the following composition formula (2):

LiₐMe_{b}Y_{c}X₆ formula (2)

In the formula (2), a, b, and c may satisfy a+mb+3c=6 and c>0. The element Me is at least one selected from the group consisting of metal elements other than Li and Y and metalloid elements. m denotes the valence of the element Me. When the element Me includes a plurality of types of elements, mb denotes the total value obtained by multiplying the component ratio of each element by the valence of the corresponding element. For example, when Me includes an element Me1 and an element Me2, mb is represented by m₁b₁+m₂b₂, wherein b₁ denotes the component ratio of the element Me1, m₁ denotes the valence of the element Me1, b₂ denotes the component ratio of the element Me2, and m₂ denotes the valence of the element Me2. In the composition formula (2), the element X denotes at least one selected from the group consisting of F, Cl, Br, and I.

The element Me is, for example, at least one selected from the group consisting of Mg, Ca, Sr, Ba, Zn, Sc, Al, Ga, Bi, Zr, Hf, Ti, Sn, Ta, Gd, and Nb.

The halide solid electrolyte is, for example, the following material. The following material further improves the ionic conductivity of the solid electrolyte 101 and can improve the ionic conductivity of a solid electrolyte sheet formed from the solid electrolyte composition 1000. This solid electrolyte sheet can further improve the output characteristics of the battery.

The halide solid electrolyte may be a material represented by the following composition formula (A1):

Li_{6-3d}Y_{d}X₆ formula (A1)

In the composition formula (A1), the element X denotes at least one selected from the group consisting of Cl, Br, and I. In the composition formula (A1), d satisfies 0<d<2.

The halide solid electrolyte may be a material represented by the following composition formula (A2):

Li₃YX₆ formula (A2)

In the composition formula (A2), the element X denotes at least one selected from the group consisting of Cl, Br, and I.

The halide solid electrolyte may be a material represented by the following composition formula (A3):

$${Li}_{3 - 3 δ} {Y}_{1 + δ} {Cl}_{6} \qquad formula ( A3 )$$

In the composition formula (A3), δ satisfies 0<δ≤0.15.

The halide solid electrolyte may be a material represented by the following composition formula (A4):

$${Li}_{3 - 3 δ} {Y}_{1 + δ} {Br}_{6} \qquad formula ( A4 )$$

In the composition formula (A4), δ satisfies 0<δ≤0.25.

The halide solid electrolyte may be a material represented by the following composition formula (A5):

$${Li}_{3 - 3 δ + a} {Y}_{1 + δ - a} {Me}_{a} {Cl}_{6 - x - y} {Br}_{x} {I}_{y} \qquad formula ( A5 )$$

In the composition formula (A5), the element Me denotes at least one selected from the group consisting of Mg, Ca, Sr, Ba, and Zn.

Furthermore, in the composition formula (A5),

$$- 1 < δ < 2 ,$$

$$0 \leq a < 3 ,$$

$$0 < ( 3 - 3 δ + a ) ,$$

$$0 < ( 1 + δ - a ) ,$$

$$0 \leq x \leq 6 ,$$

$$0 \leq y \leq 6 , and$$

$$( x + y ) \leq 6$$

are satisfied.

The halide solid electrolyte may be a material represented by the following composition formula (A6):

$${Li}_{3 - 3 δ} {Y}_{1 + δ - a} {Me}_{a} {Cl}_{6 - x - y} {Br}_{x} {I}_{y} \qquad formula ( A6 )$$

In the composition formula (A6), the element Me denotes at least one selected from the group consisting of Al, Sc, Ga, and Bi.

Furthermore, in the composition formula (A6),

$$- 1 < δ < 1 ,$$

$$0 < a < 2 ,$$

$$0 < ( 1 + δ - a ) ,$$

$$0 \leq x \leq 6 ,$$

$$0 \leq y \leq 6 , and$$

$$( x + y ) \leq 6$$

are satisfied.

The halide solid electrolyte may be a material represented by the following composition formula (A7):

$${Li}_{3 - 3 δ - a} {Y}_{1 + δ - a} {Me}_{a} {Cl}_{6 - x - y} {Br}_{x} {I}_{y} \qquad formula ( A7 )$$

In the composition formula (A7), the element Me denotes at least one selected from the group consisting of Zr, Hf, and Ti.

Furthermore, in the composition formula (A7),

$$- 1 < δ < 1 ,$$

$$0 < a < 1 \text{.5} ,$$

$$0 < ( 3 - 3 δ - a ) ,$$

$$0 < ( 1 + δ - a ) ,$$

$$0 \leq x \leq 6 ,$$

$$0 \leq y \leq 6 , and$$

$$( x + y ) \leq 6$$

are satisfied.

The halide solid electrolyte may be a material represented by the following composition formula (A8):

$${Li}_{3 - 3 δ - 2 a} {Y}_{1 + δ - a} {Me}_{a} {Cl}_{6 - x - y} {Br}_{x} {I}_{y} \qquad formula ( A8 )$$

In the composition formula (A8), the element Me denotes at least one selected from the group consisting of Ta and Nb.

Furthermore, in the composition formula (A8),

$$- 1 < δ < 1 ,$$

$$0 < a < 1 \text{.2} ,$$

$$0 < ( 3 - 3 δ - 2 a ) ,$$

$$0 < ( 1 + δ - a ) ,$$

$$0 \leq x \leq 6 ,$$

$$0 \leq y \leq 6 , and$$

$$( x + y ) \leq 6$$

are satisfied.

The halide solid electrolyte may be a compound containing Li, M2, O (oxygen), and X2. The element M2 includes, for example, at least one selected from the group consisting of Nb and Ta. X2 denotes at least one selected from the group consisting of F, Cl, Br, and I.

The compound containing Li, M2, X2, and O (oxygen) may be represented by, for example, the composition formula: LiₓM2O_{y}X2_{5+x-2y}. x may satisfy 0.1<x<7.0. y may satisfy 0.4<y<1.9.

More specifically, the halide solid electrolyte is, for example, Li₃Y(Cl,Br,I)₆, Li_{2.7}Y_{1.1}(Cl,Br,I)₆, Li₂Mg(F,Cl,Br,I)₄, Li₂Fe(F,Cl,Br,I)₄, Li(Al,Ga,In)(F,Cl,Br,I)₄, Li₃(Al,Ga,In)(F,Cl,Br,I)₆, Li₃(Ca,Y,Gd)(Cl,Br,I)₆, Li_{2.7}(Ti,A₁)F₆, Li_{2.5}(Ti,Al) F₆, Li(Ta,Nb)O(F,Cl)₄, or the like. In the present disclosure, an element represented by, for example, “(Al,Ga,In)” in the formula refers to at least one element selected from the group of elements in parentheses. More specifically, “(Al,Ga,In)” is synonymous with “at least one selected from the group consisting of Al, Ga, and In”. The same applies to other elements.

The polymeric solid electrolyte is, for example, a compound of a polymer and a lithium salt. The polymer may have an ethylene oxide structure. A polymer with an ethylene oxide structure can contain a large amount of lithium salt. Thus, the ionic conductivity can be further improved. The lithium salt may be LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, or the like. The lithium salt may be used alone or in combination.

The complex hydride solid electrolyte is, for example, LiBH₄—LiI or LiBH₄—P₂S₅.

The solid electrolyte 101 may have any shape and may be needle-like, spherical, ellipsoidal, or the like. The solid electrolyte 101 may be particulate.

When the solid electrolyte 101 is particulate (for example, spherical), the solid electrolyte 101 may have a median size of 1 μm or more and 100 μm or less or 1 μm or more and 10 μm or less. The solid electrolyte 101 with a median size of 1 μm or more and 100 μm or less can be easily dispersed in the solvent 102.

When the solid electrolyte 101 is particulate (for example, spherical), the solid electrolyte 101 may have a median size of 0.1 μm or more and 5 μm or less or 0.5 μm or more and 3 μm or less. When the solid electrolyte 101 has a median size of 0.1 μm or more and 5 μm or less, a solid electrolyte sheet produced from the solid electrolyte composition 1000 can have higher surface smoothness and a denser structure.

The median size refers to the particle size at which the cumulative volume in the volumetric particle size distribution is equal to 50%. The volumetric particle size distribution can be determined by a laser diffraction scattering method. The same applies to other materials described below.

The solid electrolyte 101 may have a specific surface area of 0.1 m²/g or more and 100 m²/g or less or 1 m²/g or more and 10 m²/g or less. The solid electrolyte 101 with a specific surface area of 0.1 m²/g or more and 100 m²/g or less can be easily dispersed in the solvent 102. The specific surface area can be measured by a BET multipoint method using a gas adsorption measuring apparatus.

The solid electrolyte 101 may have an ionic conductivity of 0.01 mS/cm² or more, 0.1 mS/cm² or more, or 1 mS/cm² or more. The solid electrolyte 101 with an ionic conductivity of 0.01 mS/cm² or more can improve the output characteristics of the battery.

### <Binder>

The binder 103 in the solid electrolyte composition 1000 can improve the wettability of the solid electrolyte 101 to the solvent 102 and thereby improve the dispersibility of the solid electrolyte 101. Furthermore, the binder 103 can suppress aggregation of particles of the solid electrolyte 101 in the solid electrolyte composition 1000 and thereby improve dispersion stability. The binder 103 can improve adhesion between particles of the solid electrolyte 101 in a solid electrolyte sheet.

The binder 103 contains a styrene elastomer. The styrene elastomer refers to an elastomer containing a repeating unit derived from styrene. The repeating unit refers to a molecular structure derived from a monomer and may also be referred to as a constitutional unit. The styrene elastomer has high flexibility and elasticity and is therefore suitable for the binder 103 of a solid electrolyte sheet. The repeating unit content derived from styrene in the styrene elastomer is, for example, but not limited to, 10% by mass or more and 70% by mass or less.

The styrene elastomer may be a block copolymer including a first block composed of a repeating unit derived from styrene and a second block composed of a repeating unit derived from a conjugated diene. The conjugated diene may be butadiene, isoprene, or the like. The repeating unit derived from a conjugated diene may be hydrogenated. Thus, the repeating unit derived from a conjugated diene may or may not have an unsaturated bond, such as a carbon-carbon double bond. The block copolymer may have a triblock sequence composed of two first blocks and one second block. The block copolymer may be an ABA triblock copolymer. In this triblock copolymer, the A block corresponds to the first block, and the B block corresponds to the second block. The first block functions as, for example, a hard segment. The second block functions as, for example, a soft segment.

The styrene elastomer may be a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), a styrene-butadiene rubber (SBR), a styrene-butadiene-styrene block copolymer (SBS), a styrene-isoprene-styrene block copolymer (SIS), a hydrogenated styrene-butadiene rubber (HSBR), or the like. The binder 103 may contain SBR or SEBS as the styrene elastomer. The binder 103 may be a mixture containing two or more selected from these The styrene elastomer has high flexibility and elasticity, and the binder 103 containing the styrene elastomer can therefore improve the surface smoothness of a solid electrolyte sheet produced from the solid electrolyte composition 1000. Furthermore, the binder 103 containing the styrene elastomer can impart flexibility to the solid electrolyte sheet. This can reduce the thickness of an electrolyte layer of a battery including the solid electrolyte sheet and improve the energy density of the battery.

The styrene elastomer may be a styrene triblock copolymer. The styrene triblock copolymer may be a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), a styrene-butadiene-styrene block copolymer (SBS), a styrene-isoprene-styrene block copolymer (SIS), or the like. These styrene triblock copolymers are sometimes referred to as styrene thermoplastic elastomers. These styrene triblock copolymers tend to be flexible and have high strength.

The styrene elastomer has a total nitrogen content of 30 ppm or more and 130 ppm or less. The styrene elastomer may have a total nitrogen content of 30 ppm or more and 110 ppm or less, 30 ppm or more and 80 ppm or less, or 30 ppm or more and 50 ppm or less. The total nitrogen content can be determined with a total nitrogen microanalyzer.

For example, the mass (μg) of nitrogen (N) contained in 1 g of a polymer is measured with a total nitrogen microanalyzer (TN-2100H) manufactured by Nittoseiko Analytech Co., Ltd. using a pyridine/toluene solution as a standard sample. The total nitrogen content is the ratio of the mass (μg) of nitrogen (N) contained in 1 g of the polymer (μg/g=ppm).

The styrene elastomer may contain a modifying group containing a nitrogen atom. The modifying group refers to a functional group that chemically modifies all the repeating units included in the polymer chain, part of the repeating units included in the polymer chain, or a terminal portion of the polymer chain. The modifying group can be introduced into a polymer chain by a substitution reaction, an addition reaction, or the like. The modifying group containing a nitrogen atom is a functional group containing nitrogen, for example, an amino group, a nitrile group, a nitro group, or the like. The modifying group containing a nitrogen atom can be introduced into a polymer chain, for example, by reacting a modifying agent. A compound for the modifying agent may be an amine compound, an isocyanate compound, an isothiocyanate compound, an isocyanuric acid derivative, a carbonyl compound containing a nitrogen group, a vinyl compound containing a nitrogen group, an epoxy compound containing a nitrogen group, an alkoxy silicon compound containing a nitrogen group, or the like. The position of the modifying group may be an end of the polymer chain. A styrene elastomer having a modifying group at an end of the polymer chain can have an effect similar to that of a so-called surfactant. Thus, when a styrene elastomer having a modifying group at an end of the polymer chain is used, the modifying group is adsorbed to the solid electrolyte 101, and the polymer chain can suppress aggregation of particles of the solid electrolyte 101. This can further improve the dispersibility of the solid electrolyte 101. The styrene elastomer is, for example, a terminal amine modified styrene elastomer. The styrene elastomer is, for example, a styrene elastomer having a nitrogen atom at at least one end of the polymer chain and having a star polymer structure centered on an alkoxysilane substituent containing nitrogen.

The nitrogen ratio with respect to the polymer chain of the styrene elastomer may be 2.0 or more, 2.5 or more, or 3.0 or more. The upper limit of the nitrogen ratio with respect to the polymer chain is, for example, but not limited to, 10. When the nitrogen ratio with respect to the polymer chain is 2.0 or more, in the solid electrolyte composition 1000, each polymer chain of the styrene elastomer tends to be adsorbed to the solid electrolyte 101 without waste. Thus, even a small amount of the binder 103 added can improve the dispersibility of the solid electrolyte 101.

The nitrogen ratio with respect to the polymer chain of the styrene elastomer is the ratio of the amount of substance (mol) of nitrogen contained in 1 g of the polymer to the amount of substance (mol) of the polymer contained in 1 g of the polymer. It can be calculated using the following formula (i) based on the weight-average molecular weight (M_{w}, unit: g/mol) and the total nitrogen content (n, unit: ppm) of the styrene elastomer.

Nitrogen ratio with respect to polymer chain=M_{w}×n/14,000,000 formula (i)

The styrene elastomer may further have a modifying group containing an atom other than a nitrogen atom, in addition to the modifying group containing a nitrogen atom. The modifying group containing an atom other than a nitrogen atom has, for example, an element with relatively high electronegativity, such as O, S, F, Cl, Br, or F, or an element with relatively low electronegativity, such as Si, Sn, or P. The modifying group containing such an element can impart polarity to the styrene elastomer. The modifying group may be a carboxy group, an acid anhydride group, an acyl group, a hydroxy group, a sulfo group, a sulfanyl group, a phosphate group, a phosphonate group, an isocyanate group, an epoxy group, a silyl group, or the like. A specific example of the acid anhydride group is a maleic anhydride group. The modifying group may be a functional group that can be introduced by reacting a modifying agent with the following compound. The compound for the modifying agent may be an epoxy compound, an ether compound, an ester compound, a mercapto group derivative, a thiocarbonyl compound, a silicon halide compound, an epoxidized silicon compound, a vinylated silicon compound, an alkoxy silicon compound, a halogenated tin compound, an organotin carboxylate compound, a phosphite compound, a phosphino compound, or the like. The styrene elastomer having the modifying group can further improve the dispersibility of the solid electrolyte 101 contained in the solid electrolyte composition 1000. This can also improve the peel strength of the solid electrolyte sheet and an electrode sheet by the interaction with a current collector.

The styrene elastomer may have a weight-average molecular weight (M_{w}) of 200,000 or more. The styrene elastomer may have a weight-average molecular weight of 300,000 or more, 500,000 or more, 800,000 or more, or 1,000,000 or more. The weight-average molecular weight has an upper limit of, for example, 1,500,000. When the styrene elastomer has a weight-average molecular weight of 200,000 or more, an excessive increase in the total nitrogen content of the styrene elastomer can be reduced. Furthermore, particles of the solid electrolyte 101 can be bound together with sufficient adhesive strength. When the styrene elastomer has a weight-average molecular weight of 1,500,000 or less, the ionic conduction between particles of the solid electrolyte 101 is less likely to be inhibited by the binder 103, and the output characteristics of the battery can be improved. The weight-average molecular weight of the styrene elastomer contained in the binder 103 can be specified, for example, by gel permeation chromatography (GPC) measurement using polystyrene as a standard sample. In other words, the weight-average molecular weight is a polystyrene equivalent value. In the GPC measurement, chloroform may be used as an eluent. When two or more peak tops are observed in a chart obtained by the GPC measurement, the weight-average molecular weight calculated from the entire peak range including the peak tops can be regarded as the weight-average molecular weight of the styrene elastomer.

In the styrene elastomer, the ratio of the degree of polymerization of a repeating unit derived from styrene to the degree of polymerization of a repeating unit derived from other than styrene is defined as m:n. At this time, in the styrene elastomer, the mole fraction (φ) of the repeating unit derived from styrene can be calculated using φ=m/(m+n). In the styrene elastomer, the mole fraction (φ) of the repeating unit derived from styrene can be determined, for example, by proton nuclear magnetic resonance (¹H NMR) measurement.

In the styrene elastomer, the mole fraction (φ) of the repeating unit derived from styrene may be 0.05 or more and 0.55 or less or 0.1 or more and 0.3 or less. The styrene elastomer with φ of 0.05 or more can improve the strength of the solid electrolyte sheet. The styrene elastomer with φ of 0.55 or less can improve the flexibility of the solid electrolyte sheet.

The styrene elastomer may include at least one selected from the group consisting of a modified SEBS and a modified SBR. The modified SEBS refers to SEBS into which a modifying group has been introduced. The modified SBR refers to SBR into which a modifying group has been introduced. The modifying group includes a modifying group containing a nitrogen atom. The modifying group may further include a modifying group containing an atom other than a nitrogen atom. The modified SEBS or modified SBR may be produced by solution polymerization or may be produced by solution anionic polymerization using an organolithium catalyst. The solution anionic polymerization is a production method excellent in the control of the molecular weight of the polymer and the amount of modifying group to be introduced. Thus, a modified SEBS produced by the solution polymerization or a modified SBR produced by the solution polymerization can be used to produce a more optimal solid electrolyte composition 1000.

The styrene elastomer may include a modified SBR. The styrene elastomer may be a modified SBR. The modified SBR tends to be more easily compressed in hot pressing than the modified SEBS. This can further improve the filling characteristics of the ionic conductor 111 contained in a solid electrolyte sheet produced from the solid electrolyte composition 1000.

The styrene elastomer may be an oil-extended polymer containing a process oil or the like to improve processability. The process oil is, for example, an aromatic oil, a paraffinic oil, a naphthenic oil, a vegetable oil, an oil with a low polycyclic aromatic compound content (low PCA oil), or the like. The process oil may be a low PCA oil. The low PCA oil is, for example, a mild extraction solvate (MES), an oil produced by treating an aromatic extract from a distillate oil (TDAE), a special aromatic extract from a residual oil (SRAE), a heavy naphthenic oil, or the like. The ratio of the mass of the process oil to the mass of the styrene elastomer is, for example, but not limited to, 10% by mass or more and 100% by mass or less. When the binder 103 contains the process oil, the process oil can serve as a lubricant and improve the filling characteristics of the ionic conductor 111.

The ratio of the mass of the process oil to the mass of the styrene elastomer may be 1% by mass or less. When the ratio of the mass of the process oil to the mass of the styrene elastomer is 1% by mass or less, the reaction between the process oil and the solid electrolyte can be suppressed, and the cycle characteristics of the battery can be improved. When the styrene elastomer is an oil-extended polymer, the oil contained in the styrene elastomer can be removed by dissolving the styrene elastomer in tetrahydrofuran (THF) followed by washing by reprecipitation in ethanol and reprecipitation in acetone.

The binder 103 may contain a resin binder other than the styrene elastomer, such as a binding agent that can be generally used as a battery binder. The binder 103 may be a styrene elastomer. In other words, the binder 103 may contain only the styrene elastomer.

The binding agent may be poly(vinylidene difluoride) (PVDF), polytetrafluoroethylene (PTFE), polyethylene, polypropylene, an aramid resin, polyamide, polyimide, polyamideimide, polyacrylonitrile, poly(acrylic acid), poly(methyl acrylate), poly(ethyl acrylate), poly(hexyl acrylate), poly(methacrylic acid), poly(methyl methacrylate) (PMMA), poly(ethyl methacrylate), poly(hexyl methacrylate), poly(vinyl acetate), polyvinylpyrrolidone, polyether, polycarbonate, poly(ether sulfone), poly(ether ketone), poly(ether ketone), poly(phenylene sulfide), hexafluoropolypropylene, a styrene-butadiene rubber, carboxymethyl cellulose, ethyl cellulose, or the like. The binding agent may also be a copolymer synthesized using two or more monomers selected from the group consisting of tetrafluoroethylene, hexafluoroethylene, hexafluoropropylene, perfluoroalkyl vinyl ether, vinylidene fluoride, chlorotrifluoroethylene, ethylene, propylene, butadiene, isoprene, styrene, pentafluoropropylene, fluoromethyl vinyl ether, acrylate, acrylic acid, and hexadiene. These may be used alone or in combination.

The binding agent may contain an elastomer from the perspective of good binding properties. An elastomer refers to a polymer with rubber elasticity. The elastomer used as a binding agent may be a thermoplastic elastomer or a thermosetting elastomer. The elastomer may be, in addition to the styrene elastomer, a butadiene rubber (BR), an isoprene rubber (IR), a chloroprene rubber (CR), an acrylonitrile-butadiene rubber (NBR), a hydrogenated isoprene rubber (HIR), a hydrogenated butyl rubber (HIIR), a hydrogenated nitrile rubber (HNBR), an acrylate butadiene rubber (ABR), or the like. A mixture containing two or more selected from these may be used.

### <Ionic Conductor>

As described above, the ionic conductor 111 contains the solid electrolyte 101 and the binder 103. In the ionic conductor 111, a plurality of particles of the solid electrolyte 101 are bound via the binder 103. In the ionic conductor 111, for example, particles of the solid electrolyte 101 are uniformly dispersed by the binder 103 adsorbed to the solid electrolyte 101.

In the ionic conductor 111, the ratio of the mass of the binder 103 to the mass of the solid electrolyte 101 may be, but is not limited to, 0.1% by mass or more and 10% by mass or less, 0.5% by mass or more and 5% by mass or less, or 1% by mass or more and 3% by mass or less. When the ratio of the mass of the binder 103 to the mass of the solid electrolyte 101 is 0.1% by mass or more, a solid electrolyte sheet produced from the solid electrolyte composition 1000 can have improved strength. When the ratio of the mass of the binder 103 to the mass of the solid electrolyte 101 is 10% by mass or less, the decrease in the ionic conductivity of the ionic conductor 111 can be reduced.

The ionic conductor 111 can be produced, for example, by mixing the solid electrolyte 101 and the binder 103. The mixing method is, for example, but not limited to, a method of mechanically pulverizing and mixing the solid electrolyte 101 and the binder 103 in a dry manner. The mixing method may also be a wet method of preparing a solution or a dispersion liquid containing the binder 103, dispersing the solid electrolyte 101 in the solution or the dispersion liquid, and mixing the solution or the dispersion liquid. The binder 103 and the solid electrolyte 101 can be simply and uniformly mixed by the wet method. The solid electrolyte composition 1000 may be produced by producing the ionic conductor 111 in a solvent by the wet method.

### <Solvent>

The solvent 102 may be an organic solvent. The organic solvent is a compound containing carbon and is, for example, a compound containing an element, such as carbon, hydrogen, nitrogen, oxygen, sulfur, or halogen.

The solvent 102 may contain at least one selected from the group consisting of a hydrocarbon, a compound having a halogen group, and a compound having an ether bond.

The hydrocarbon is a compound composed only of carbon and hydrogen. The hydrocarbon may be an aliphatic hydrocarbon. The hydrocarbon may be a saturated hydrocarbon or an unsaturated hydrocarbon. The hydrocarbon may be linear or branched. The number of carbons in the hydrocarbon may be, but is not limited to, 7 or more. The hydrocarbon can be used to produce the solid electrolyte composition 1000 in which the ionic conductor 111 is well dispersed. This can also reduce the decrease in the ionic conductivity of the solid electrolyte 101 due to mixing with the solvent 102.

The hydrocarbon may have a ring structure. The ring structure may be an alicyclic hydrocarbon or an aromatic hydrocarbon. The ring structure may be monocyclic or polycyclic. When the hydrocarbon has a ring structure, the ionic conductor 111 can be easily dispersed in the solvent 102. From the perspective of improving the dispersibility of the ionic conductor 111 in the solid electrolyte composition 1000, the hydrocarbon may include an aromatic hydrocarbon. Thus, the solvent 102 may contain an aromatic hydrocarbon. The hydrocarbon may be an aromatic hydrocarbon. A styrene elastomer is easily dissolved in an aromatic hydrocarbon. Thus, when the binder 103 contains a styrene elastomer and the solvent 102 contains an aromatic hydrocarbon, the binder 103 can be more efficiently adsorbed to the solid electrolyte 101 in the solid electrolyte composition 1000. This can further improve the ability of the solid electrolyte composition 1000 to retain the solvent. Furthermore, an aromatic hydrocarbon has relatively low polarity. Thus, when the solvent 102 contains an aromatic hydrocarbon, excessive adsorption of the solvent 102 to the solid electrolyte can be suppressed. Furthermore, when the solvent 102 contains an aromatic hydrocarbon, the decrease in ionic conductivity due to a reaction between the solid electrolyte and the solvent 102 can be reduced.

In the compound having a halogen group, a portion other than the halogen group may be composed only of carbon and hydrogen. Thus, the compound having a halogen group refers to a compound in which at least one hydrogen atom of a hydrocarbon is substituted with a halogen group. The halogen group may be F, Cl, Br, or I. The halogen group may be at least one selected from the group consisting of F, Cl, Br, and I. Substituting at least one hydrogen atom of a hydrocarbon by a halogen group can impart a relatively low polarity to the hydrocarbon. When the compound having a halogen group is used for the solvent 102, the ionic conductor 111 can be easily dispersed in the solvent 102, and the solid electrolyte composition 1000 can therefore have high dispersibility. Consequently, a solid electrolyte sheet produced from the solid electrolyte composition 1000 can have high ionic conductivity and a denser structure.

The number of carbons in the compound having a halogen group may be, but is not limited to, 7 or more. Thus, the compound having a halogen group is less likely to volatilize, and the solid electrolyte composition 1000 can therefore be stably produced. The compound having a halogen group may have a high molecular weight. Thus, the compound having a halogen group may have a high boiling point.

The compound having a halogen group may have a ring structure. The ring structure may be an alicyclic hydrocarbon or an aromatic hydrocarbon. The ring structure may be monocyclic or polycyclic. When the compound having a halogen group has a ring structure, the ionic conductor 111 can be easily dispersed in the solvent 102. From the perspective of enhancing the dispersibility of the ionic conductor 111 in the solid electrolyte composition 1000, the compound having a halogen group may include an aromatic hydrocarbon. The compound having a halogen group may be an aromatic hydrocarbon substituted with a halogen group.

The compound having a halogen group may have only a halogen group as a functional group. In such a case, the compound having a halogen group may have any number of halogens. The halogen group may be at least one selected from the group consisting of F, Cl, Br, and I. When such a compound is used for the solvent 102, the ionic conductor 111 can be easily dispersed in the solvent 102, and the solid electrolyte composition 1000 can therefore have high dispersibility. Consequently, a solid electrolyte sheet produced from the solid electrolyte composition 1000 can have high ionic conductivity and a denser structure. When such a compound is used for the solvent 102, a solid electrolyte sheet produced from the solid electrolyte composition 1000 can easily have a dense structure with few pinholes, irregularities, and the like.

The compound having a halogen group may be a halogenated hydrocarbon. The halogenated hydrocarbon refers to a compound in which all hydrogens of a hydrocarbon are substituted with a halogen group. When the halogenated hydrocarbon is used for the solvent 102, the ionic conductor 111 can be easily dispersed in the solvent 102, and the solid electrolyte composition 1000 can therefore have high dispersibility. Consequently, a solid electrolyte sheet produced from the solid electrolyte composition 1000 can have high ionic conductivity and a denser structure. When such a compound is used for the solvent 102, a solid electrolyte sheet produced from the solid electrolyte composition 1000 can easily have, for example, a dense structure with few pinholes, irregularities, and the like.

In the compound having an ether bond, a portion other than the ether bond may be composed only of carbon and hydrogen. Thus, the compound having an ether bond refers to a compound in which at least one C—C bond of a hydrocarbon is substituted with a C—O—C bond. Substituting at least one C—C bond of a hydrocarbon by a C—O—C bond can impart a relatively low polarity to the hydrocarbon. When the compound having an ether bond is used for the solvent 102, the ionic conductor 111 can be easily dispersed in the solvent 102. Thus, the solid electrolyte composition 1000 can have high dispersibility. Consequently, a solid electrolyte sheet produced from the solid electrolyte composition 1000 can have high ionic conductivity and a denser structure.

The compound having an ether bond may have a ring structure. The ring structure may be an alicyclic hydrocarbon or an aromatic hydrocarbon. The ring structure may be monocyclic or polycyclic. When the compound having an ether bond has a ring structure, the ionic conductor 111 can be easily dispersed in the solvent 102. From the perspective of enhancing the dispersibility of the ionic conductor 111 in the solid electrolyte composition 1000, the compound having an ether bond may include an aromatic hydrocarbon. The compound having an ether bond may be an aromatic hydrocarbon substituted with an ether group.

The solvent 102 may be ethylbenzene, mesitylene, pseudocumene, p-xylene, cumene, tetralin, m-xylene, dibutyl ether, 1,2,4-trichlorobenzene, chlorobenzene, 2,4-dichlorotoluene, anisole, o-chlorotoluene, m-dichlorobenzene, p-chlorotoluene, o-dichlorobenzene, 1,4-dichlorobutane, 3,4-dichlorotoluene, or the like. These may be used alone or in combination.

From the perspective of cost, the solvent 102 may be commercially available xylene, that is, mixed xylene. The solvent 102 is, for example, mixed xylene of o-xylene, m-xylene, p-xylene, and ethylbenzene mixed at a mass ratio of 24:42:18:16.

The solvent 102 may contain tetralin. Tetralin has a relatively high boiling point. Tetralin not only improves the ability of the solid electrolyte composition 1000 to retain the solvent, but also allows the solid electrolyte composition 1000 to be stably produced by a kneading process.

The solvent 102 may have a boiling point of 100° C. or more and 250° C. or less, 130° C. or more and 230° C. or less, 150° C. or more and 220° C. or less, or 180° C. or more and 210° C. or less. The solvent 102 may be a liquid at normal temperature (25° C.). Such a solvent is less likely to volatilize at normal temperature, and the solid electrolyte composition 1000 can therefore be stably produced. Thus, the solid electrolyte composition 1000 can be easily applied to the surface of an electrode or a base material. The solvent 102 in the solid electrolyte composition 1000 can be easily removed by drying described later.

The solvent 102 may have a water content of 10 ppm by mass or less. Reducing the water content can reduce the decrease in ionic conductivity due to a reaction of the solid electrolyte 101. The water content may be reduced by a dehydration method using a molecular sieve, by a dehydration method using bubbling of an inert gas, such as a nitrogen gas or an argon gas, or the like. The dehydration method using bubbling of an inert gas can reduce the water content and perform deoxidation. The water content can be measured with a Karl Fischer water determination apparatus.

The solvent 102 disperses the ionic conductor 111. The solvent 102 can be a liquid in which the solid electrolyte 101 can be dispersed. The solid electrolyte 101 may not be dissolved in the solvent 102. When the solid electrolyte 101 is not dissolved in the solvent 102, it is possible to produce the solid electrolyte composition 1000 in which an ion-conducting phase formed at the time of producing the solid electrolyte 101 is maintained. Thus, a solid electrolyte sheet produced using the solid electrolyte composition 1000 can reduce the decrease in ionic conductivity.

The solvent 102 may partially or completely dissolve the solid electrolyte 101. Dissolving the solid electrolyte 101 can improve the denseness of a solid electrolyte sheet produced using the solid electrolyte composition 1000.

### <Solid Electrolyte Composition>

The solid electrolyte composition 1000 may be a paste or a dispersion liquid. The ionic conductor 111 is, for example, particles. In the solid electrolyte composition 1000, the particles of the ionic conductor 111 are mixed with the solvent 102. In the production of the solid electrolyte composition 1000, the ionic conductor 111 and the solvent 102 may be mixed by any method, or the solid electrolyte 101, the solvent 102, and the binder 103 may be mixed by any method. For example, a mixing method using a mixing apparatus of a stirring type, a shaking type, an ultrasonic type, a rotary type, or the like may be mentioned. For example, a mixing method using a dispersing and kneading apparatus, such as a high-speed homogenizer, a thin-film rotary high-speed mixer, an ultrasonic homogenizer, a ball mill, a bead mill, a planetary mixer, a sand mill, a rolling mill, or a kneader, may be mentioned. These mixing methods may be used alone or in combination.

The solid electrolyte composition 1000 is produced, for example, by the following method. First, the solid electrolyte 101 and the solvent 102 are mixed, and a binder solution or the like is added thereto. The resulting liquid mixture is subjected to high-speed shear treatment using an in-line dispersing and pulverizing machine. Through such a process, the ionic conductor 111 is formed and is dispersed and stabilized in the solvent 102. Thus, the solid electrolyte composition 1000 with higher fluidity can be produced. The solid electrolyte composition 1000 may also be produced by mixing the solvent 102 with the ionic conductor 111 prepared in advance and subjecting the resulting liquid mixture to high-speed shear treatment.

The solid electrolyte composition 1000 may also be produced by the following method. First, the solid electrolyte 101 and the solvent 102 are mixed, and a binder solution or the like is added thereto. The resulting liquid mixture is subjected to high shear treatment using an ultrasonic homogenizer. Through such a process, the ionic conductor 111 is formed and is dispersed and stabilized in the solvent 102. Thus, the solid electrolyte composition 1000 with higher fluidity can be produced. The solid electrolyte composition 1000 may also be produced by mixing the solvent 102 with the ionic conductor 111 prepared in advance and subjecting the resulting liquid mixture to high shear treatment using ultrasonic waves.

From the perspective of producing the solid electrolyte composition 1000 with high fluidity, the high-speed shear treatment or the high shear treatment using ultrasonic waves may be performed under the conditions in which the particles of the solid electrolyte 101 are not pulverized and the particles of the solid electrolyte 101 are disintegrated.

The binder solution is, for example, a solution containing the binder 103 and the solvent 102. The composition of the solvent contained in the binder solution may be the same as or different from the composition of the solvent contained in the dispersion liquid of the solid electrolyte 101.

The solid concentration (NV) of the solid electrolyte composition 1000 is appropriately determined according to the particle size of the solid electrolyte 101, the specific surface area of the solid electrolyte 101, the type of the solvent 102, and the type of the binder 103. The solid concentration may be 20% by mass or more and 70% by mass or less or 30% by mass or more and 60% by mass or less. With a solid concentration of 20% by mass or more, the solid electrolyte composition 1000 can have high viscosity and is less likely to drip when the solid electrolyte composition 1000 is applied to a substrate, such as an electrode. With a solid concentration of 70% by mass or less, the solid electrolyte composition 1000 can have a relatively large wet film thickness when applied to a substrate, and a solid electrolyte sheet with a more uniform film thickness can be produced.

The dispersibility of the solid electrolyte 101 in the solid electrolyte composition 1000 can be evaluated by pulsed NMR measurement. The dispersibility can be specified by the following method. First, a solid electrolyte composition with a solid concentration (NV) adjusted to 50% by mass is prepared. Next, the prepared solid electrolyte composition is placed in a glass sample tube, and a relaxation curve is obtained using a pulsed NMR apparatus (minispec mq20) manufactured by Bruker AXS K.K. The measurement conditions are described below.

### [Measurement Conditions]

Nucleus observed: hydrogen (¹H)
Relaxation time to be measured: transverse relaxation time T₂
Pulse sequence: CPMG method
Pulse interval [90 degrees to 180 degrees]: 1 ms
Measurement temperature: 25° C.

The resulting relaxation curve separated into two components is analyzed. A faster relaxation component is defined as a component 1, a slower relaxation component is defined as a component 2, and the ratio [%] of each component is determined. The faster relaxation component (the component 1) is presumed to be a strongly bound solvent near the solid electrolyte. The slower relaxation component (the component 2) is presumed to be a solvent that is away from the solid electrolyte and is more weakly bound than the component 1. It is found that the dispersibility of the solid electrolyte 101 in the solid electrolyte composition 1000 increases as the ratios of the components become balanced, that is, the ratio of the component 1 approaches 50%. When the binder 103 is less adsorbed to the solid electrolyte 101, the solvent 102 may be excessively adsorbed to the solid electrolyte 101. This results in a higher ratio of the component 1, showing poor dispersibility. On the other hand, when the binder 103 is more adsorbed to the solid electrolyte 101, the solvent 102 may be insufficiently adsorbed to the solid electrolyte 101. This results in a lower ratio of the component 1, showing poor dispersibility.

The ratio of the component 1 may be 43% or more and 57% or less, 45% or more and 55% or less, or 48% or more and 52% or less.

### Second Embodiment

A second embodiment is described below. The description overlapping with the first embodiment is omitted as appropriate.

An electrode composition 2000 may be a fluid slurry. The electrode composition 2000 with fluidity can form an electrode sheet by a wet method, such as a coating method. The “electrode sheet” may be a free-standing sheet member or may be a positive electrode layer or a negative electrode layer supported by a current collector, a base material, or an electrode assembly.

### [Electrode Composition]

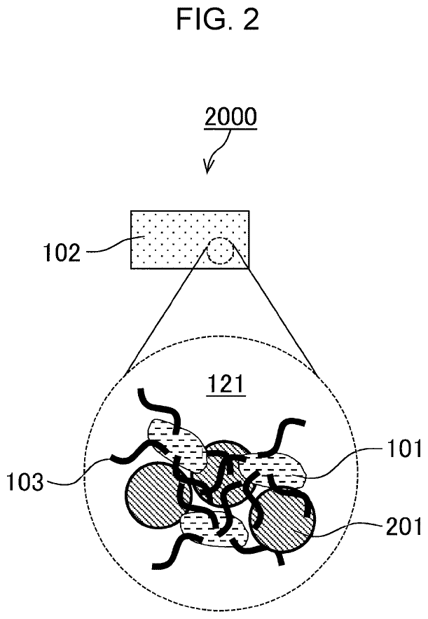

FIG. 2 is a schematic view of the electrode composition 2000 according to the second embodiment. The electrode composition 2000 contains an ionic conductor 121 and the solvent 102. The ionic conductor 121 contains the solid electrolyte 101, the binder 103, and an active material 201. The ionic conductor 121 is dispersed or dissolved in the solvent 102. Thus, the solid electrolyte 101, the binder 103, and the active material 201 are dispersed or dissolved in the solvent 102. In other words, the electrode composition 2000 contains the active material 201 and the solid electrolyte composition 1000. Thus, the electrode composition 2000 is composed of the solid electrolyte composition 1000 and the active material 201. The solid electrolyte composition 1000 contains the solid electrolyte 101, the solvent 102, and the binder 103. The solid electrolyte composition 1000 is as described in the first embodiment. The electrode composition 2000 has the same features and effects as the solid electrolyte composition 1000. The active material 201 is described in detail below.

### <Active Material>

The active material 201 in the second embodiment contains a material that can adsorb and desorb metal ions (for example, lithium ions). The active material 201 contains, for example, a positive-electrode active material or a negative-electrode active material. When the electrode composition 2000 contains the active material 201, an electrode sheet produced from the electrode composition 2000 can be used to produce a lithium secondary battery.

The active material 201 contains, for example, as a positive-electrode active material, a material that can adsorb and desorb metal ions (for example, lithium ions). The positive-electrode active material may be a lithium-containing transition metal oxide, a transition metal fluoride, a polyanionic material, a fluorinated polyanionic material, a transition metal sulfide, a transition metal oxysulfide, a transition metal oxynitride, or the like. The lithium-containing transition metal oxide may be Li(NiCoAl)O₂, Li(NiCoMn)O₂, LiCoO₂, or the like. For example, the use of a lithium-containing transition metal oxide as a positive-electrode active material can reduce the production costs of the electrode composition 2000 and improve the average discharge voltage of the battery. Li(NiCoAl)O₂ means that Ni, Co, and Al are contained at an arbitrary ratio. Li(NiCoMn)O₂ means that Ni, Co, and Mn are contained at an arbitrary ratio.

The positive-electrode active material may have a median size of 0.1 μm or more and 100 μm or less or 1 μm or more and 10 μm or less. When the positive-electrode active material has a median size of 0.1 μm or more, the active material 201 can be easily dispersed in the solvent 102 in the electrode composition 2000. This improves the charge-discharge characteristics of a battery including an electrode sheet produced from the electrode composition 2000. A positive-electrode active material with a median size of 100 μm or less has an improved lithium diffusion rate. Thus, the battery can operate at high output power.

The active material 201 contains, for example, as a negative-electrode active material, a material that can adsorb and desorb metal ions (for example, lithium ions). The negative-electrode active material may be a metallic material, a carbon material, an oxide, a nitride, a tin compound, a silicon compound, or the like. The metallic material may be a single metal or an alloy. The metallic material may be a lithium metal, a lithium alloy, or the like. The carbon material may be natural graphite, coke, graphitizing carbon, carbon fiber, spherical carbon, artificial graphite, amorphous carbon, or the like. The use of silicon (Si), tin (Sn), a silicon compound, a tin compound, or the like can improve the capacity density of the battery. The use of an oxide compound containing titanium (Ti) or niobium (Nb) can improve the safety of the battery.

The negative-electrode active material may have a median size of 0.1 μm or more and 100 μm or less or 1 μm or more and 10 μm or less. When the negative-electrode active material has a median size of 0.1 μm or more, the active material 201 can be easily dispersed in the solvent 102 in the electrode composition 2000. This improves the charge-discharge characteristics of a battery including an electrode sheet produced from the electrode composition 2000. A negative-electrode active material with a median size of 100 μm or less has an improved lithium diffusion rate. Thus, the battery can operate at high output power.

The positive-electrode active material and the negative-electrode active material may be covered with a coating material to reduce the interfacial resistance between the active material and the solid electrolyte. Thus, a coating layer may be provided on the surface of the positive-electrode active material and the negative-electrode active material. The coating layer is a layer containing a coating material. The coating material may be a material with low electronic conductivity. The coating material may be an oxide material, an oxide solid electrolyte, a halide solid electrolyte, a sulfide solid electrolyte, or the like. The positive-electrode active material and the negative-electrode active material may be coated with only one coating material selected from the materials described above. Thus, the coating layer may be formed of only one coating material selected from the materials described above. Alternatively, two or more coating layers may be provided by using two or more coating materials selected from the materials described above.

The oxide material used as the coating material may be SiO₂, Al₂O₃, TiO₂, B₂O₃, Nb₂O₅, WO₃, ZrO₂, or the like.

The oxide solid electrolyte used as the coating material may be the oxide solid electrolyte exemplified in the first embodiment. Examples thereof include Li—Nb—O compounds, such as LiNbO₃, Li—B—O compounds, such as LiBO₂ and Li₃BO₃, Li—Al—O compounds, such as LiAlO₂, Li—Si—O compounds, such as Li₄SiO₄, Li₂SO₄, Li—Ti—O compounds, such as Li₄Ti₅Oi₂, Li—Zr—O compounds, such as Li₂ZrO₃, Li—Mo—O compounds, such as Li₂MoO₃, Li—V—O compounds, such as LiV₂O₅, Li—W—O compounds, such as Li₂WO₄, and Li—P—O compounds, such as LiPO₄. The oxide solid electrolyte has high potential stability. Thus, the use of the oxide solid electrolyte as the coating material can further improve the cycle performance of the battery.

The halide solid electrolyte used as the coating material may be the halide solid electrolyte exemplified in the first embodiment. Examples thereof include Li—Y—Cl compounds, such as LiYCl₆, Li—Y—Br—Cl compounds, such as LiYBr₂Cl₄, Li—Ta—O—Cl compounds, such as LiTaOCl₄, and Li—Ti—Al—F compounds, such as Li_{2.7}Ti_{0.3}Al_{0.7}F₆. The halide solid electrolyte has high ionic conductivity and high potential stability. Thus, the use of the halide solid electrolyte as the coating material can further improve the cycle performance of the battery.

The sulfide solid electrolyte used as the coating material may be the sulfide solid electrolyte exemplified in the first embodiment. For example, a Li—P—S compound, such as Li₂S—P₂S₅, or the like may be mentioned. The sulfide solid electrolyte has a high ionic conductivity and a low Young's modulus. Thus, the use of the sulfide solid electrolyte as the coating material can form a uniform coating and can further improve the cycle performance of the battery.

### <Electrode Composition>

The electrode composition 2000 may be a paste or a dispersion liquid. The active material 201 and the ionic conductor 121 are, for example, particles. To produce the electrode composition 2000, the particles of the active material 201 and the ionic conductor 121 are mixed with the solvent 102. In the production of the electrode composition 2000, a method of mixing the active material 201, the ionic conductor 121, and the solvent 102, that is, a method of mixing the active material 201, the solid electrolyte 101, the binder 103, and the solvent 102 is not particularly limited. For example, a mixing method using a mixing apparatus of a stirring type, a shaking type, an ultrasonic type, a rotary type, or the like may be mentioned. For example, a mixing method using a dispersing and kneading apparatus, such as a high-speed homogenizer, a thin-film rotary high-speed mixer, an ultrasonic homogenizer, a ball mill, a bead mill, a planetary mixer, a sand mill, a rolling mill, or a kneader, may be mentioned. These mixing methods may be used alone or in combination.

The electrode composition 2000 is produced, for example, by the following method. First, the active material 201 and the solvent 102 are mixed, and a binder solution is added thereto. The resulting liquid mixture is subjected to high-speed shear treatment using an in-line dispersing and pulverizing machine. The solid electrolyte 101 and the binder solution are added to the resulting dispersion liquid. The resulting liquid mixture is subjected to high-speed shear treatment using an in-line dispersing and pulverizing machine. Through such a process, the ionic conductor 121 is formed, and the active material 201 and the ionic conductor 121 are dispersed and stabilized in the solvent 102. Thus, the electrode composition 2000 with higher fluidity can be produced. The electrode composition 2000 may also be produced by mixing the solvent 102, the ionic conductor 121 prepared in advance, and the active material 201 and subjecting the resulting liquid mixture to high-speed shear treatment. The electrode composition 2000 may also be produced by mixing the solid electrolyte composition 1000 prepared in advance with the active material 201 and subjecting the resulting liquid mixture to high-speed shear treatment.

The electrode composition 2000 may be produced, for example, by the following method. First, the active material 201 and the solvent 102 are mixed, and a binder solution is added thereto. The resulting liquid mixture is subjected to high shear treatment using an ultrasonic homogenizer. The solid electrolyte 101 and the binder solution are added to the resulting dispersion liquid. The resulting liquid mixture is subjected to high shear treatment using an ultrasonic homogenizer. Through such a process, the ionic conductor 121 is formed, and the active material 201 and the ionic conductor 121 are dispersed and stabilized in the solvent 102. Thus, the electrode composition 2000 with higher fluidity can be produced. The electrode composition 2000 may also be produced by mixing the solvent 102, the ionic conductor 121 prepared in advance, and the active material 201 and subjecting the resulting liquid mixture to high shear treatment using ultrasonic waves. The electrode composition 2000 may also be produced by mixing the solid electrolyte composition 1000 prepared in advance with the active material 201 and subjecting the resulting liquid mixture to high shear treatment using ultrasonic waves.

From the perspective of producing the electrode composition 2000 with high fluidity, the high-speed shear treatment or the high shear treatment using ultrasonic waves may be performed under the conditions in which the particles of the solid electrolyte 101 and the active material 201 are not pulverized and the particles of the solid electrolyte 101 and the particles of the active material 201 are disintegrated.

The electrode composition 2000 may contain a conductive aid for the purpose of improving electronic conductivity. The conductive aid may be graphite, such as natural graphite or artificial graphite, carbon black, such as acetylene black or Ketjen black, electrically conductive fiber, such as carbon fiber or metal fiber, an electrically conductive powder of fluorocarbon, aluminum, or the like, an electrically conductive whisker of zinc oxide, potassium titanate, or the like, an electrically conductive metal oxide, such as titanium oxide, an electrically conductive polymer, such as polyaniline, polypyrrole, or polythiophene, or the like. The use of a carbon material as a conductive aid can reduce the cost.

In the electrode composition 2000, the ratio of the mass of the ionic conductor 121 to the mass of the active material 201 is, for example, but not limited to, 10% by mass or more and 150% by mass or less, 20% by mass or more and 100% by mass or less, or 30% by mass or more and 70% by mass or less. The ionic conductor 121 with a mass ratio of 10% by mass or more can improve the ionic conductivity in the electrode composition 2000 and can provide a battery with higher output power. The ionic conductor 121 with a mass ratio of 150% by mass or less can provide a battery with a higher energy density.

The solid concentration of the electrode composition 2000 is appropriately determined according to the particle size of the active material 201, the specific surface area of the active material 201, the particle size of the solid electrolyte 101, the specific surface area of the solid electrolyte 101, the type of the solvent 102, and the type of the binder 103. The electrode composition 2000 may have a solid concentration of 40% by mass or more and 90% by mass or less or 50% by mass or more and 80% by mass or less. With a solid concentration of 40% by mass or more, the electrode composition 2000 can have high viscosity and is less likely to drip when the electrode composition 2000 is applied to a substrate, such as an electrode. With a solid concentration of 90% by mass or less, the electrode composition 2000 can have a relatively large wet film thickness when applied to a substrate, and an electrode sheet with a more uniform film thickness can be produced.

### Third Embodiment

A third embodiment is described below. The description overlapping with the first embodiment or the second embodiment is omitted as appropriate.

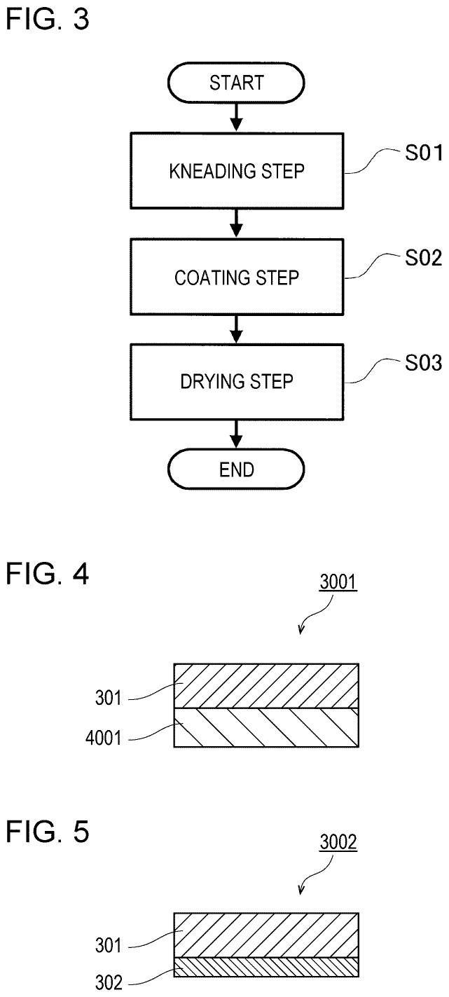

A method for producing a solid electrolyte sheet is described below with reference to FIG. 3. FIG. 3 is a flow chart of a method for producing a solid electrolyte sheet.

The method for producing a solid electrolyte sheet may include a step S01, a step S02, and a step S03. The method for producing a solid electrolyte sheet includes applying the solid electrolyte composition 1000 to an electrode or a base material to form a coating film and removing a solvent from the coating film. The step S01 in FIG. 3 has been described in the first embodiment. The method for producing a solid electrolyte sheet includes the step S02 of applying the solid electrolyte composition 1000 and the step S03 of drying the solid electrolyte composition 1000. The step S01, the step S02, and the step S03 may be performed in this order. Through these steps, the solid electrolyte composition 1000 can be used to produce a solid electrolyte sheet in which the solid electrolyte 101 is well dispersed. As described above, a solid electrolyte sheet is produced by applying and drying the solid electrolyte composition 1000. In other words, a solid electrolyte sheet is a solidified product of the solid electrolyte composition 1000. The solid electrolyte sheet in which the solid electrolyte 101 is well dispersed tends to have high surface smoothness.

FIG. 4 is a cross-sectional view of an electrode assembly 3001 according to the third embodiment. The electrode assembly 3001 includes an electrode 4001 and a solid electrolyte sheet 301 disposed on the electrode 4001. The electrode assembly 3001 can be produced by including a step of applying the solid electrolyte composition 1000 to the electrode 4001 as the step S02.

FIG. 5 is a cross-sectional view of a transfer sheet 3002 according to the third embodiment. The transfer sheet 3002 includes a base material 302 and the solid electrolyte sheet 301 disposed on the base material 302. The transfer sheet 3002 can be produced by including a step of applying the solid electrolyte composition 1000 to the base material 302 as the step S02.

In the step S02, the solid electrolyte composition 1000 is applied to the electrode 4001 or the base material 302. Thus, a coating film of the solid electrolyte composition 1000 is formed on the electrode 4001 or the base material 302.

The electrode 4001 is a positive electrode or a negative electrode. The positive electrode or the negative electrode includes a current collector and an active material layer disposed on the current collector. The solid electrolyte composition 1000 is applied to the electrode 4001 and, through the step S03 described later, the electrode assembly 3001 formed of a laminate of the electrode 4001 and the solid electrolyte sheet 301 is produced.

A material used for the base material 302 may be a metal foil or a resin film. A material of the metal foil may be copper (Cu), aluminum (Al), iron (Fe), nickel (Ni), an alloy thereof, or the like. A material of the resin film may be poly(ethylene terephthalate) (PET), polyimide (PI), polytetrafluoroethylene (PTFE), or the like. The solid electrolyte composition 1000 is applied to the base material 302 and, through the step S03 described later, the transfer sheet 3002 formed of a laminate of the base material 302 and the solid electrolyte sheet 301 is produced.

The coating method may be a die coating method, a gravure coating method, a doctor blade method, a bar coating method, a spray coating method, an electrostatic coating method, or the like. From the perspective of mass productivity, a die coating method may be performed.

In the step S03, the solid electrolyte composition 1000 applied to the electrode 4001 or the base material 302 is dried. Drying the solid electrolyte composition 1000, for example, removes the solvent 102 from the coating film of the solid electrolyte composition 1000 and produces the solid electrolyte sheet 301.

A drying method for removing the solvent 102 from the solid electrolyte composition 1000 may be warm air/hot air drying, infrared heating drying, drying under reduced pressure, vacuum drying, high-frequency dielectric heating drying, high-frequency induction heating drying, or the like. These may be used alone or in combination.

The solvent 102 may be removed from the solid electrolyte composition 1000 by drying under reduced pressure. Thus, the solvent 102 may be removed from the solid electrolyte composition 1000 in an atmosphere at a pressure lower than atmospheric pressure. The atmosphere at a pressure lower than atmospheric pressure may have a gauge pressure of, for example, −0.01 MPa or less. The drying under reduced pressure may be performed at 50° C. or more and 250° C. or less.

The solvent 102 may be removed from the solid electrolyte composition 1000 by vacuum drying. Thus, the solvent 102 may be removed from the solid electrolyte composition 1000 in an atmosphere at a temperature lower than the boiling point of the solvent 102 and at a pressure equal to or lower than the equilibrium vapor pressure of the solvent 102.

From the perspective of production costs, the solvent 102 may be removed from the solid electrolyte composition 1000 by warm air/hot air drying. The set temperature of the warm air/hot air drying may be 50° C. or more and 250° C. or less or 80° C. or more and 150° C. or less.

In the step S03, the amount of the solvent 102 removed from the solid electrolyte composition 1000 can be adjusted by the drying method and conditions.

Removal of the solvent 102 can be confirmed, for example, by Fourier transform infrared spectroscopy (FT-IR), X-ray photoelectron spectroscopy (XPS), gas chromatography (GC), or gas chromatography-mass spectrometry (GC/MS). The solvent 102 may not be completely removed as long as the solid electrolyte sheet 301 after drying has ionic conductivity. The solvent 102 may partially remain in the solid electrolyte sheet 301.

The solid electrolyte sheet 301 may have an ionic conductivity of 0.1 mS/cm or more or 1 mS/cm or more. At an ionic conductivity of 0.1 mS/cm or more, the battery can have improved output characteristics. Furthermore, for the purpose of improving the ionic conductivity of the solid electrolyte sheet 301, press forming may be performed with a pressing machine or the like.

### Fourth Embodiment

A fourth embodiment is described below. The description overlapping with the first to third embodiments is omitted as appropriate.

A method for producing an electrode sheet is the same as the method for producing the solid electrolyte sheet 301 described in the third embodiment except that the base in the production of the solid electrolyte sheet 301 described in the third embodiment is partially different. Thus, the method for producing an electrode sheet is also described below with reference to FIG. 3. In other words, FIG. 3 also corresponds to a flow chart showing the method for producing an electrode sheet.

The method for producing an electrode sheet may include a step S01, a step S02, and a step S03. The method for producing an electrode sheet includes applying the electrode composition 2000 to a current collector, a base material, or an electrode assembly to form a coating film and removing a solvent from the coating film. The step S01 in FIG. 3 has been described in the second embodiment. The method for producing an electrode sheet includes the step S02 of applying the electrode composition 2000 and the step S03 of drying the electrode composition 2000. The step S01, the step S02, and the step S03 may be performed in this order. Through these steps, the electrode composition 2000 can be used to produce an electrode sheet in which the solid electrolyte 101 is well dispersed. Thus, an electrode sheet is produced by applying and drying the electrode composition 2000. In other words, an electrode sheet is a solidified product of the electrode composition 2000. The electrode sheet in which the solid electrolyte 101 is well dispersed tends to have high surface smoothness. Furthermore, the electrode sheet in which the solid electrolyte 101 is well dispersed can improve the ionic conductivity in the electrode and improve the output characteristics of a battery produced from the electrode sheet.

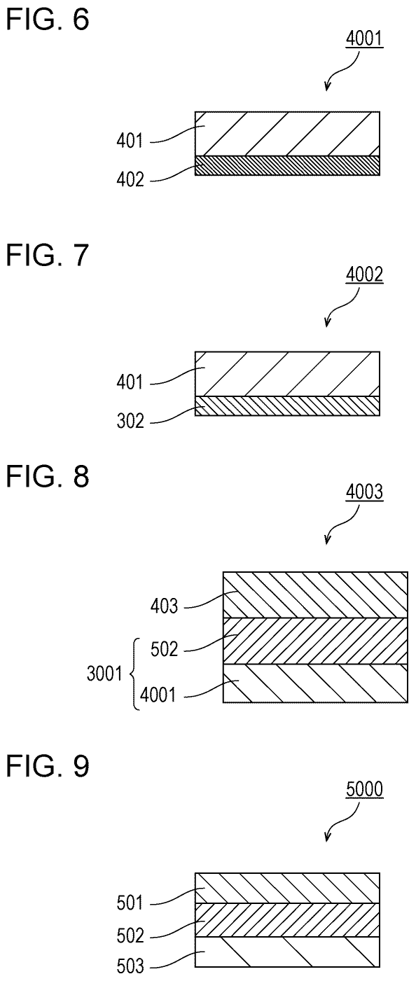

FIG. 6 is a cross-sectional view of an electrode 4001 according to the fourth embodiment. The electrode 4001 includes a current collector 402 and an electrode sheet 401 disposed on the current collector 402. The electrode 4001 can be produced by including a step of applying the electrode composition 2000 to the current collector 402 as the step S02.

FIG. 7 is a cross-sectional view of an electrode transfer sheet 4002 in the fourth embodiment. The electrode transfer sheet 4002 includes the base material 302 and the electrode sheet 401 disposed on the base material 302. The electrode transfer sheet 4002 can be produced by including a step of applying the electrode composition 2000 to the base material 302 as the step S02.

FIG. 8 is a cross-sectional view of a battery precursor 4003 according to the fourth embodiment. The battery precursor 4003 includes the electrode 4001, an electrolyte layer 502, and an electrode sheet 403. The electrolyte layer 502 is disposed on the electrode 4001. Furthermore, the electrode sheet 403 is disposed on the electrolyte layer 502. The electrode 4001 includes a current collector 402 and an electrode sheet 401 disposed on the current collector 402. The electrode assembly 3001 includes the electrode 4001 and the electrolyte layer 502 disposed on the electrode 4001. The electrolyte layer 502 includes the solid electrolyte sheet 301.

In the step S02, the electrode composition 2000 is applied to the current collector 402. Thus, a coating film of the electrode composition 2000 is formed on the current collector 402.

The coating method may be a die coating method, a gravure coating method, a doctor blade method, a bar coating method, a spray coating method, an electrostatic coating method, or the like. From the perspective of mass productivity, a die coating method may be performed.

A material used for the current collector 402 may be a metal foil. A material of the metal foil may be copper (Cu), aluminum (Al), iron (Fe), nickel (Ni), an alloy thereof, or the like. A coating layer composed of the conductive aid and the binding agent may be provided on the surface of the metal foil. The electrode composition 2000 is applied to the current collector 402 and, through the step S03 described later, the electrode 4001 formed of a laminate of the current collector 402 and the electrode sheet 401 is produced.

Next, the electrolyte layer 502 is formed on the electrode 4001. A method for forming the electrolyte layer 502 is as described in the third embodiment. More specifically, the solid electrolyte composition 1000 is applied to the electrode 4001 and, through the step S03, the electrolyte layer 502 is formed on the electrode 4001. Thus, the electrode assembly 3001 formed of a laminate of the electrode 4001 and the electrolyte layer 502 is produced.

In the step S03, the applied solid electrolyte composition 1000 is dried. Drying the solid electrolyte composition 1000, for example, removes the solvent 102 from the coating film of the solid electrolyte composition 1000 and produces the electrolyte layer 502.

The electrode sheet 403 is then formed on the electrolyte layer 502. A method for forming the electrode sheet 403 is, for example, the same as the method for forming the electrode sheet 401. More specifically, the electrode composition 2000 is applied to the electrolyte layer 502 and, through the step S03, the electrode sheet 403 is formed on the electrolyte layer 502.

In the step S03, the applied electrode composition 2000 is dried. Drying the electrode composition 2000, for example, removes the solvent 102 from the coating film of the electrode composition 2000 and produces the electrode sheet 403.

The battery precursor 4003 may be produced, for example, by combining the electrode 4001 and the electrode sheet 403 with a polarity opposite the polarity of the electrode 4001. Thus, an active material contained in the electrode sheet 401 is different from an active material contained in the electrode sheet 403. More specifically, when an active material contained in the electrode sheet 401 is a positive-electrode active material, an active material contained in the electrode sheet 403 is a negative-electrode active material. When an active material contained in the electrode sheet 401 is a negative-electrode active material, an active material contained in the electrode sheet 403 is a positive-electrode active material.

### Fifth Embodiment

A fifth embodiment is described below. The description overlapping with the first to fourth embodiments is omitted as appropriate.

FIG. 9 is a cross-sectional view of a battery 5000 according to the fifth embodiment.

The battery 5000 according to the fifth embodiment includes a positive electrode 501, a negative electrode 503, and the electrolyte layer 502.

The electrolyte layer 502 is disposed between the positive electrode 501 and the negative electrode 503.

The battery 5000 includes the positive electrode 501, the electrolyte layer 502, and the negative electrode 503 in this order.

The electrolyte layer 502 may include the solid electrolyte sheet 301 according to the third embodiment, and the positive electrode 501 or the negative electrode 503 may include the electrode sheet 401 according to the fourth embodiment.

The battery 5000 may include the solid electrolyte sheet 301 in which the solid electrolyte 101 is well dispersed. The solid electrolyte sheet 301 in which the solid electrolyte 101 is well dispersed tends to have high surface smoothness. The solid electrolyte sheet 301 with a smooth surface means that the solid electrolyte sheet 301 has a small variation in thickness. The solid electrolyte sheet 301 with a small variation in thickness can have a thickness close to the design value at all positions in the plane thereof. This can reduce the possibility of contact (a short circuit) between the positive electrode 501 and the negative electrode 503 and improve the energy density of the battery 5000, even when the electrolyte layer 502 is made thinner.

The battery 5000 may include the electrode sheet 401 in which the solid electrolyte 101 is well dispersed. The electrode sheet 401 in which the solid electrolyte 101 is well dispersed tends to have high surface smoothness. The electrode sheet 401 with a smooth surface means that the electrode sheet 401 has a small variation in thickness. The electrode sheet 401 with a small variation in thickness can have a thickness close to the design value at all positions in the plane thereof. This can reduce the possibility of contact (a short circuit) between the positive electrode 501 and the negative electrode 503 and improve the energy density of the battery 5000, even when the electrolyte layer 502 is made thinner. The electrode sheet 401 in which the solid electrolyte 101 is well dispersed tends to have high ionic conduction in the electrode. This can improve the output characteristics of the battery 5000.

In the battery 5000, at least one selected from the group consisting of the positive electrode 501 and the negative electrode 503 may be the electrode 4001. The battery 5000 may be produced, for example, by combining the electrode 4001 and an electrode with a polarity opposite the polarity of the electrode 4001. This method is good from the perspective of reducing the number of components. When the electrode 4001 is a positive electrode, the electrode with a polarity opposite the polarity of the electrode 4001 is a negative electrode. When the electrode 4001 is a negative electrode, the electrode with a polarity opposite the polarity of the electrode 4001 is a positive electrode. The positive electrode or the negative electrode includes a current collector and an active material layer disposed on the current collector. The active material layer of the positive electrode or the active material layer of the negative electrode may be provided with a layer containing a solid electrolyte.

A method for producing the battery 5000 may be a transfer method or a coating method. The transfer method is a method for producing the battery 5000 using the transfer sheet 3002 and the electrode transfer sheet 4002. Thus, the transfer method is a method for producing the battery 5000 by producing each member of the battery 5000 in a separate step and combining these members. The coating method is, for example, a method for producing the battery 5000 including a method of applying the solid electrolyte composition 1000 to a positive electrode or a negative electrode and drying the solid electrolyte composition 1000 to directly form an electrolyte layer on the positive electrode or the negative electrode.

An example of a method for producing the battery 5000 by the transfer method is described below.

In the battery 5000, the electrolyte layer 502 may be produced using the transfer sheet 3002. In such a case, first, the solid electrolyte sheet 301 is transferred from the transfer sheet 3002 to a first electrode. Then, the battery 5000 can be produced by combining the first electrode, a second electrode, and the electrolyte layer 502 such that the electrolyte layer 502 including the transferred solid electrolyte sheet 301 is disposed between the first electrode and the second electrode. Thus, a method for producing the battery 5000 includes applying the solid electrolyte composition 1000 to the base material 302 to form a coating film and removing the solvent 102 from the coating film to form the electrolyte layer 502. Furthermore, the method for producing the battery 5000 includes combining the first electrode, the second electrode, and the electrolyte layer 502 such that the electrolyte layer 502 is positioned between the first electrode and the second electrode. Thus, the battery 5000 including the first electrode, the electrolyte layer, and the second electrode in this order is produced. The electrolyte layer 502 includes the solid electrolyte sheet 301. Thus, the electrolyte layer 502 contains a solidified product of the solid electrolyte composition 1000. To transfer the solid electrolyte sheet 301 from the transfer sheet 3002 to the first electrode, the transfer sheet 3002 is disposed on the first electrode such that the solid electrolyte sheet 301 is in contact with the first electrode, and then the base material 302 is removed. Thus, the solid electrolyte sheet 301 is transferred to the first electrode. The second electrode is then disposed on the solid electrolyte sheet 301 such that the solid electrolyte sheet 301 is in contact with the second electrode. Thus, the battery 5000 is produced. When the solid electrolyte sheet 301 and the second electrode are combined, the electrode transfer sheet 4002 including the second electrode may be used. When the first electrode is a positive electrode, the second electrode is a negative electrode. When the first electrode is a negative electrode, the second electrode is a positive electrode. The positive electrode and the negative electrode include a current collector and an active material layer on the current collector. The active material layer of the positive electrode or the active material layer of the negative electrode may be provided with a layer containing a solid electrolyte.

The battery 5000 may be produced using the electrode transfer sheet 4002 according to the fourth embodiment. In such a case, first, the electrode sheet 401 is transferred from the electrode transfer sheet 4002 to the electrolyte layer 502. The transferred electrode sheet 401 is then combined with the current collector 402. A laminate of the electrode sheet 401 and the current collector 402 is defined as a first electrode. The battery 5000 may be produced by combining the first electrode and a second electrode with a polarity opposite the polarity of the first electrode such that the electrolyte layer 502 is disposed between the first electrode and the second electrode. Thus, a method for producing the battery 5000 includes applying the electrode composition 2000 to the base material 302 to form a coating film and removing the solvent 102 from the coating film to form the electrode sheet 401 for the first electrode. Furthermore, the method for producing the battery 5000 includes combining the first electrode, the second electrode, and the electrolyte layer 502 such that the electrolyte layer 502 is positioned between the first electrode and the second electrode. Thus, the battery 5000 including the first electrode, the electrolyte layer, and the second electrode in this order is produced. As described above, the first electrode includes the electrode sheet 401. Thus, the first electrode contains a solidified product of the electrode composition 2000. The second electrode may contain a solidified product of the electrode composition 2000. To transfer the electrode sheet 401 from the electrode transfer sheet 4002 to the electrolyte layer 502, the electrode transfer sheet 4002 is disposed on the electrolyte layer 502 such that the electrode sheet 401 is in contact with the electrolyte layer 502, and then the base material 302 is removed. Thus, the electrode sheet 401 is transferred to the electrolyte layer 502. The transferred electrode sheet 401 is then combined with the current collector 402. The second electrode is then disposed on the electrolyte layer 502 such that the electrolyte layer 502 is in contact with the second electrode. Thus, the battery 5000 is produced. When the first electrode is a positive electrode, the second electrode is a negative electrode. When the first electrode is a negative electrode, the second electrode is a positive electrode. The positive electrode and the negative electrode include a current collector and an active material layer on the current collector.

The battery 5000 may also be produced using the transfer sheet 3002 and the electrode transfer sheet 4002. In such a case, first, the electrode sheet 401 is transferred from the electrode transfer sheet 4002 to the current collector 402. Thus, the electrode 4001 formed of a laminate of the current collector 402 and the electrode sheet 401 is produced. The electrode 4001 is, for example, the first electrode. The solid electrolyte sheet 301 is then transferred from the transfer sheet 3002 to the first electrode. More specifically, the solid electrolyte sheet 301 is transferred to the electrode sheet 401. Thus, the electrode assembly 3001, which is the laminate of the electrode 4001 and the solid electrolyte sheet 301, is produced. Then, the battery 5000 can be produced by combining the electrode assembly 3001 and the second electrode. To combine the electrode assembly 3001 and the second electrode, the electrode transfer sheet 4002 including the second electrode may be used. Thus, a method for producing the battery 5000 includes applying the electrode composition 2000 to a first base material to form a first coating film and removing the solvent 102 from the first coating film to form a first electrode. Furthermore, the method for producing the battery 5000 includes applying the solid electrolyte composition 1000 to a second base material to form a second coating film and removing the solvent 102 from the second coating film to form the electrolyte layer 502. Furthermore, the method for producing the battery 5000 includes combining the first electrode, the second electrode, and the electrolyte layer 502 such that the electrolyte layer 502 is positioned between the first electrode and the second electrode. Thus, the battery 5000 including the first electrode, the electrolyte layer, and the second electrode in this order is produced. At least one selected from the group consisting of the first electrode and the second electrode includes the electrode sheet 401. Thus, at least one selected from the group consisting of the first electrode and the second electrode contains a solidified product of the electrode composition 2000. The electrolyte layer 502 includes the solid electrolyte sheet 301. Thus, the electrolyte layer contains a solidified product of the solid electrolyte composition 1000.

When the transfer sheet 3002 is used in the method for producing the battery 5000, the solid electrolyte sheet 301, the positive electrode, and the negative electrode are produced in separate steps. This eliminates the need to consider the influence of a solvent used in the production of the solid electrolyte sheet 301 on the positive electrode and the negative electrode in the production of the battery 5000. Thus, various solvents can be used in the production of the solid electrolyte sheet 301.

In the method for producing the battery 5000, when the electrode transfer sheet 4002 is used, the electrode sheet 401 and the electrolyte layer 502 are produced in separate steps. This eliminates the need to consider the influence of a solvent used in the production of the electrode sheet 401 on the electrolyte layer 502 in the production of the battery 5000. Thus, various solvents can be used in the production of the electrode sheet 401.

An example of a method for producing the battery 5000 by the coating method is described below.

A method for producing the battery 5000 includes, for example, applying the solid electrolyte composition 1000 to a first electrode to form a coating film and removing the solvent 102 from the coating film to form the electrode assembly 3001 including a laminate of the first electrode and the electrolyte layer 502. Furthermore, the method for producing the battery 5000 includes combining the first electrode, the second electrode, and the electrolyte layer 502 such that the electrolyte layer 502 is positioned between the first electrode and the second electrode. Thus, the battery 5000 including the first electrode, the electrolyte layer, and the second electrode in this order is produced. The electrolyte layer 502 includes the solid electrolyte sheet 301. For example, the battery 5000 is produced by disposing the second electrode on the solid electrolyte sheet 301. A method for disposing the second electrode on the solid electrolyte sheet 301 may be a method of applying the electrode composition 2000 to the solid electrolyte sheet 301, a method of transferring an electrode sheet or the second electrode to the solid electrolyte sheet 301, or the like. When the first electrode is a positive electrode, the second electrode is a negative electrode. When the first electrode is a negative electrode, the second electrode is a positive electrode. Each of the first electrode and the second electrode includes, for example, a current collector and an active material layer disposed on the current collector. The active material layer of the first electrode or the active material layer of the second electrode may be provided with a layer containing a solid electrolyte.

A method for producing the battery 5000 includes, for example, applying the electrode composition 2000 to the current collector 402 to form a coating film and removing the solvent 102 from the coating film to form a first electrode. Furthermore, the method for producing the battery 5000 includes combining the first electrode, a second electrode, and the electrolyte layer 502 such that the electrolyte layer 502 is positioned between the first electrode and the second electrode. Thus, the battery 5000 including the first electrode, the electrolyte layer, and the second electrode in this order is produced. The electrolyte layer 502 includes the solid electrolyte sheet 301. For example, the battery 5000 is produced by disposing the second electrode on the solid electrolyte sheet 301. A method for disposing the second electrode on the solid electrolyte sheet 301 may be a method of applying the electrode composition 2000 to the solid electrolyte sheet 301, a method of transferring an electrode sheet or the second electrode to the solid electrolyte sheet 301, or the like. When the first electrode is a positive electrode, the second electrode is a negative electrode. When the first electrode is a negative electrode, the second electrode is a positive electrode. Each of the first electrode and the second electrode includes, for example, a current collector and an active material layer disposed on the current collector. The active material layer of the first electrode or the active material layer of the second electrode may be provided with a layer containing a solid electrolyte.

A method for producing the battery 5000 includes, for example, applying the electrode composition 2000 to the electrode assembly 3001 to form a coating film and removing a solvent from the coating film to form the electrode sheet 403. The battery 5000 is produced by combining the electrode sheet 403 with the current collector 402 to produce a second electrode. Thus, the battery 5000 including the first electrode, the electrolyte layer, and the second electrode in this order is produced. The electrode assembly 3001 includes the electrode 4001 and the electrolyte layer 502. The electrode 4001 is, for example, the first electrode. The electrolyte layer 502 includes the solid electrolyte sheet 301.

A method for producing the battery 5000 includes, for example, applying the electrode composition 2000 to the current collector 402 to form a first coating film and removing a solvent from the first coating film to form a first electrode. Furthermore, the method for producing the battery 5000 includes applying the solid electrolyte composition 1000 to the first electrode to form a second coating film and removing a solvent from the second coating film to form the electrolyte layer 502. Furthermore, the method for producing the battery 5000 includes combining the first electrode, a second electrode, and the electrolyte layer 502 such that the electrolyte layer 502 is positioned between the first electrode and the second electrode. More specifically, the battery 5000 is produced by applying the electrode composition 2000 including the second electrode to the electrolyte layer 502 including the solid electrolyte sheet 301 to form a third coating film and removing a solvent from the third coating film to form the second electrode including an electrode sheet. Thus, the battery 5000 including the first electrode, the electrolyte layer, and the second electrode in this order is produced.

These coating methods are superior to a transfer method of transferring the solid electrolyte sheet 301 formed on the base material 302 and the electrode sheet 401 formed on the base material 302 from the perspective of reducing the number of components. In other words, these methods have higher mass productivity than the transfer method.

The battery 5000 may also be produced by producing a laminate including a positive electrode, an electrolyte layer, and a negative electrode in this order by one of the above methods and press-forming the laminate with a pressing machine at normal temperature or a high temperature. Press forming can improve the filling characteristics of the active material 201 and the ionic conductor 121 and provide the battery 5000 with high output power.

The battery 5000 may also be produced by the following method. A negative electrode with an electrode sheet (first negative electrode sheet) laminated on a current collector, a first electrolyte layer, and a first positive electrode are disposed in this order. On the other hand, an electrode sheet (second negative electrode sheet), a second electrolyte layer, and a second positive electrode are disposed in this order on a surface of the current collector opposite the surface on which the first negative electrode sheet is laminated. A laminate thus produced includes the first positive electrode, the first electrolyte layer, the first negative electrode sheet, the current collector, the second negative electrode sheet, the second electrolyte layer, and the second positive electrode in this order. The laminate may be press-formed with a pressing machine at normal temperature or a high temperature to produce the battery 5000. A laminate of two batteries 5000 with less warping can be produced by such a method, and the battery 5000 with high output power can be more efficiently produced. In the production of the laminate, the members may be laminated in any order. For example, the first negative electrode sheet and the second electrode sheet are disposed on the current collector, and the first electrolyte layer, the second electrolyte layer, the first positive electrode, and the second positive electrode may then be laminated in this order to produce a laminate of two batteries 5000.

The electrolyte layer 502 contains an electrolyte material. The electrolyte material is, for example, a solid electrolyte. Thus, the electrolyte layer 502 may be a solid electrolyte layer. The solid electrolyte in the electrolyte layer 502 may be the solid electrolyte exemplified as the solid electrolyte 101 in the first embodiment. The solid electrolyte is, for example, a sulfide solid electrolyte, an oxide solid electrolyte, a halide solid electrolyte, a polymeric solid electrolyte, a complex hydride solid electrolyte, or the like.

The electrolyte layer 502 may contain a solid electrolyte as a main component. The term “main component” refers to a component contained in the largest amount on a mass basis. The electrolyte layer 502 may contain a solid electrolyte at a mass ratio of 70% or more (70% by mass or more) with respect to the entire electrolyte layer 502.

Such a structure can further improve the output characteristics of the battery 5000.

The electrolyte layer 502 contains a solid electrolyte as a main component and may further contain incidental impurities. The incidental impurities may be a starting material for the synthesis of a solid electrolyte, a by-product, a decomposition product, or the like.

The electrolyte layer 502 may contain a solid electrolyte at a mass ratio of 100% with respect to the entire electrolyte layer 502 except for impurities that are inevitably mixed.

Such a structure can further improve the output characteristics of the battery 5000.

The electrolyte layer 502 may contain two or more of the materials listed as the solid electrolyte. For example, the electrolyte layer 502 may contain a halide solid electrolyte and a sulfide solid electrolyte.

The electrolyte layer 502 may be a layer produced by laminating a layer containing the solid electrolyte sheet 301 and a layer containing a solid electrolyte with a composition different from the composition of the solid electrolyte 101 contained in the solid electrolyte sheet 301. The electrolyte layer 502 may be a single layer composed of the solid electrolyte sheet 301 or two or more layers composed of another solid electrolyte.

The electrolyte layer 502 may include a layer that is disposed between a layer containing the solid electrolyte sheet 301 and the negative electrode 503 and that includes a solid electrolyte with a lower reduction potential than the solid electrolyte 101 contained in the solid electrolyte sheet 301. Such a structure can reduce the reductive decomposition of the solid electrolyte 101, which may be caused by contact between the solid electrolyte 101 and a negative-electrode active material, and can therefore improve the output characteristics of the battery 5000. A solid electrolyte with a lower reduction potential than the solid electrolyte 101 is, for example, a sulfide solid electrolyte.

The electrolyte layer 502 may have a thickness of 1 μm or more and 300 μm or less. The electrolyte layer 502 with a thickness of 1 μm or more is less likely to have a short circuit between the positive electrode 501 and the negative electrode 503. When the electrolyte layer 502 has a thickness of 300 μm or less, the battery 5000 can operate easily at high output power. Thus, the electrolyte layer 502 with an appropriately adjusted thickness can be sufficiently safe and can operate at high output power.

The solid electrolyte sheet 301 in the electrolyte layer 502 may have a thickness of 1 μm or more and 30 μm or less, 1 μm or more and 15 μm or less, or 1 μm or more and 7.5 μm or less. The solid electrolyte sheet 301 with a thickness of 1 μm or more is less likely to have a short circuit between the positive electrode 501 and the negative electrode 503. When the solid electrolyte sheet 301 has a thickness of 30 μm or less, the battery 5000 can operate at high output power by reducing the internal resistance of the battery 5000 and have an improved energy density. The thickness of the solid electrolyte sheet 301 is defined, for example, by an average value of a plurality of points (for example, three points) in a cross section parallel to the thickness direction.

The solid electrolyte in the battery 5000 may have any shape. The solid electrolyte may be needle-like, spherical, ellipsoidal, or the like. The solid electrolyte may be particulate.

At least one selected from the group consisting of the positive electrode 501 and the negative electrode 503 may contain an electrolyte material and may contain, for example, a solid electrolyte. The solid electrolyte may be a solid electrolyte exemplified as a material constituting the electrolyte layer 502. Such a structure improves ionic conductivity (for example, lithium ion conductivity) in the positive electrode 501 or the negative electrode 503, and the battery 5000 can operate at high output power.

In the positive electrode 501 or the negative electrode 503, a sulfide solid electrolyte may be used as a solid electrolyte, and the halide solid electrolyte described above may be used as a coating material for coating an active material.

The active material 501 contains, for example, as a positive-electrode active material, a material that can adsorb and desorb metal ions (for example, lithium ions). The positive-electrode active material may be the material exemplified in the second embodiment.

When the solid electrolyte in the positive electrode 501 is particulate (for example, spherical), the solid electrolyte may have a median size of 100 μm or less. When the solid electrolyte has a median size of 100 μm or less, the positive-electrode active material and the solid electrolyte can be well dispersed in the positive electrode 501. This improves the charge-discharge characteristics of the battery 5000.

The solid electrolyte in the positive electrode 501 may have a smaller median size than the positive-electrode active material. This may allow the solid electrolyte and the positive-electrode active material to be well dispersed.

The positive-electrode active material may have a median size of 0.1 μm or more and 100 μm or less. When the positive-electrode active material has a median size of 0.1 μm or more, the positive-electrode active material and the solid electrolyte can be well dispersed in the positive electrode 501. This improves the charge-discharge characteristics of the battery 5000. A positive-electrode active material with a median size of 100 μm or less has an improved lithium diffusion rate. This enables the battery 5000 to operate at high output power.

In the positive electrode 501, the volume ratio “v1:100-v1” of the positive-electrode active material to the solid electrolyte in the positive electrode 201 may satisfy 30≤v1≤95. v1 denotes the volume ratio of the positive-electrode active material when the total volume of the positive-electrode active material and the solid electrolyte in the positive electrode 501 is 100. When 30≤v1 is satisfied, the battery 5000 tends to have a sufficient energy density. When v1≤95 is satisfied, the battery 5000 can operate more easily at high output power.

The positive electrode 501 may have a thickness of 10 μm or more and 500 μm or less. When the positive electrode 501 has a thickness of 10 μm or more, the battery 5000 can easily have a sufficient energy density. When the positive electrode 501 has a thickness of 500 μm or less, the battery 5000 can operate more easily at high output power.

When the positive electrode 501 includes the electrode sheet 401, the electrode sheet 401 has a thickness of 10 μm or more and 500 μm or less or 20 μm or more and 200 μm or less. When the electrode sheet 401 has a thickness of 10 μm or more, the battery 5000 can have an improved energy density. When the electrode sheet 401 has a thickness of 500 μm or less, the battery 5000 can operate at high output power by reducing the internal resistance of the battery 5000 The thickness of the electrode sheet 401 is defined, for example, by an average value of a plurality of points (for example, three points) in a cross section parallel to the thickness direction.

The negative electrode 503 contains, for example, as a negative-electrode active material, a material that can adsorb and desorb metal ions (for example, lithium ions). The negative-electrode active material may be the material exemplified in the second embodiment.

The negative-electrode active material may have a median size of 0.1 μm or more and 100 μm or less. When the negative-electrode active material has a median size of 0.1 μm or more, the negative-electrode active material and the solid electrolyte can be well dispersed in the negative electrode 503. This improves the charge-discharge characteristics of the battery 5000. A negative-electrode active material with a median size of 100 μm or less has an improved lithium diffusion rate. This enables the battery 5000 to operate at high output power.

The negative-electrode active material may have a larger median size than the solid electrolyte. This may allow the solid electrolyte and the negative-electrode active material to be well dispersed.

The volume ratio “v2:100-v2” of the negative-electrode active material to the solid electrolyte in the negative electrode 503 may satisfy 30≤v2≤95. v2 denotes the volume ratio of the negative-electrode active material when the total volume of the negative-electrode active material and the solid electrolyte in the negative electrode 503 is 100. When 30≤v2 is satisfied, the battery 5000 tends to have a sufficient energy density. When v2≤95 is satisfied, the battery 5000 can operate more easily at high output power.

The negative electrode 503 may have a thickness of 10 μm or more and 500 μm or less. When the negative electrode 503 has a thickness of 10 μm or more, the battery 5000 can easily have a sufficient energy density. When the negative electrode 503 has a thickness of 500 μm or less, the battery 5000 can operate more easily at high output power.

When the negative electrode 503 includes the electrode sheet 401, the electrode sheet 401 has a thickness of 10 μm or more and 500 μm or less or 20 μm or more and 200 μm or less. When the electrode sheet 401 has a thickness of 10 μm or more, the battery 5000 can have an improved energy density. When the electrode sheet 401 has a thickness of 500 μm or less, the battery 5000 can operate at high output power by reducing the internal resistance of the battery 5000 The thickness of the electrode sheet 401 is defined, for example, by an average value of a plurality of points (for example, three points) in a cross section parallel to the thickness direction.

The positive-electrode active material and the negative-electrode active material may be covered with a coating material to reduce the interfacial resistance between the active material and the solid electrolyte. The coating material may be a material with low electronic conductivity. The coating material may be the oxide material, the oxide solid electrolyte, the halide solid electrolyte, or the sulfide solid electrolyte exemplified in the second embodiment, or the like.

At least one selected from the group consisting of the positive electrode 501, the electrolyte layer 502, and the negative electrode 503 may contain a binding agent for the purpose of improving adhesion between particles. The binding agent may be the material exemplified in the first embodiment. When the binding agent contains an elastomer, each layer of the positive electrode 501, the electrolyte layer 502, and the negative electrode 503 in the battery 5000 tends to have high flexibility and elasticity. In such a case, the battery 5000 tends to have improved durability.

At least one selected from the group consisting of the positive electrode 501, the electrolyte layer 502, and the negative electrode 503 may contain a non-aqueous electrolyte solution, a gel electrolyte, or an ionic liquid for the purpose of facilitating the transfer of lithium ions and improving the output characteristics of the battery 5000.

The non-aqueous electrolyte solution contains a non-aqueous solvent and a lithium salt dissolved in the non-aqueous solvent. The non-aqueous solvent may be a cyclic carbonate solvent, a chain carbonate solvent, a cyclic ether solvent, a chain ether solvent, a cyclic ester solvent, a chain ester solvent, a fluorinated solvent, or the like. The cyclic carbonate solvent may be ethylene carbonate, propylene carbonate, butylene carbonate, or the like. The chain carbonate solvent may be dimethyl carbonate, ethyl methyl carbonate, diethyl carbonate, or the like. The cyclic ether solvent may be tetrahydrofuran, 1,4-dioxane, 1,3-dioxolane, or the like. The chain ether solvent may be 1,2-dimethoxyethane, 1,2-diethoxyethane, or the like. The cyclic ester solvent may be γ-butyrolactone or the like. The chain ester solvent may be methyl acetate or the like. The fluorinated solvent may be fluoroethylene carbonate, methyl fluoropropionate, fluorobenzene, fluoroethyl methyl carbonate, fluorodimethylene carbonate, or the like. The non-aqueous solvent may be a non-aqueous solvent selected from these or a mixture of two or more non-aqueous solvents selected from these.

The non-aqueous electrolyte solution may contain at least one fluorinated solvent selected from the group consisting of fluoroethylene carbonate, methyl fluoropropionate, fluorobenzene, fluoroethyl methyl carbonate, and fluorodimethylene carbonate.

The lithium salt may be LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, or the like. The lithium salt may be a lithium salt selected from these or a mixture of two or more lithium salts selected from these. The concentration of the lithium salt in the non-aqueous electrolyte solution may be 0.5 mol/l or more and 2 mol/l or less.

The gel electrolyte may be a polymer material containing a non-aqueous electrolyte solution. The polymer material may be polyethylene oxide, polyacrylonitrile, polyvinylidene difluoride, polymethyl methacrylate, a polymer with an ethylene oxide bond, or the like.

A cation constituting the ionic liquid may be an aliphatic chain quaternary cation, such as tetraalkylammonium or tetraalkylphosphonium, an alicyclic ammonium, such as pyrrolidinium, morpholinium, imidazolinium, tetrahydropyrimidinium, piperazinium, or piperidinium, a nitrogen-containing heteroaromatic cation, such as pyridinium or imidazolium, or the like. An anion constituting the ionic liquid may be PF₆⁻, BF₄⁻, SbF₆⁻, AsF₆⁻, SO₃CF₃⁻, N(SO₂F)₂⁻, N(SO₂CF₃)₂⁻, N(SO₂C₂F₅)₂⁻, N(SO₂CF₃)(SO₂C₄F₉)⁻, C(SO₂CF₃)₃⁻, or the like. The ionic liquid may contain a lithium salt.

At least one selected from the group consisting of the positive electrode 501 and the negative electrode 503 may contain a conductive aid for the purpose of improving electronic conductivity. The conductive aid may be the material exemplified in the second embodiment.

The battery 5000 may have a coin shape, a cylindrical shape, a square or rectangular shape, a sheet shape, a button shape, a flat shape, a layered shape, or the like.

### EXAMPLES

The present disclosure is described in detail in the following examples and comparative examples. A solid electrolyte composition, a solid electrolyte sheet, an electrode sheet, and a battery of the present disclosure are not limited to the following examples.

### Example 1-1

### [Solvent]

In all the following steps, a commercially available dehydrated solvent or a solvent dehydrated by nitrogen bubbling was used as a solvent. The solvent had a water content of 10 ppm by mass or less.

### [Preparation of Binder Solution]

A binder solution was prepared by adding a solvent to a binder to dissolve or disperse the binder in the solvent. The concentration of the binder in the binder solution was adjusted to 5% by mass or more and 10% by mass or less. Dehydration treatment was then performed by nitrogen bubbling until the binder solution had a water content of 10 ppm by mass or less.

In Example 1-1, tetralin was used as a solvent of the binder solution. A solution-polymerized styrene-butadiene rubber (modified SBR) was used as a styrene elastomer constituting the binder. The modified SBR was Tufdene E680 manufactured by Asahi Kasei Corporation. The modified SBR was dissolved in THF, was reprecipitated in ethanol, and was reprecipitated in acetone. The precipitate was then dried under vacuum at 100° C. to wash process oil. In this modified SBR, the mole fraction of a repeating unit derived from styrene was 0.23. “Tufdene” is a registered trademark of Asahi Kasei Corporation.

### [Preparation of Solid Electrolyte Composition]

In an argon glove box with a dew point of −60° C. or less, tetralin and the binder solution were added to Li₂S—P₂S₅ glass-ceramic (hereinafter referred to as “LPS”). These materials were mixed at a mass ratio of LPS:binder=100:3, and the solid concentration (NV) was adjusted to 51% by mass. The resulting liquid mixture was then dispersed and kneaded by high shearing using a homogenizer (HG-200 manufactured by As One Corporation) and a generator (K-20S manufactured by As One Corporation) to produce a dispersion liquid. The NV of the resulting dispersion liquid was measured with a heat-drying moisture meter (MX-50 manufactured by A&D Company, Limited), and tetralin was then added to the dispersion liquid to a NV of 50% by mass. The dispersion liquid was kneaded using a planetary mixer (ARE-310 manufactured by THINKY) at 1600 rpm for 3 minutes to produce a solid electrolyte composition of Example 1-1.

### Example 1-2

A solid electrolyte composition of Example 1-2 was produced in the same manner as in Example 1-1 except that a solution-polymerized styrene-butadiene rubber (modified SBR, manufactured by Asahi Kasei Corporation, Asaprene Y031) was used as the styrene elastomer. In the modified SBR used in Example 1-2, the mole fraction of a repeating unit derived from styrene was 0.16. “Asaprene” is a registered trademark of Asahi Kasei Corporation.

### Comparative Example 1-1

A solid electrolyte composition of Comparative Example 1-1 was produced in the same manner as in Example 1-1 except that a solution-polymerized styrene-butadiene rubber (SBR, manufactured by Asahi Kasei Corporation, Tufdene 2100R) was used as the styrene elastomer. In the SBR used in Comparative Example 1-1, the mole fraction of a repeating unit derived from styrene was 0.16.

### Comparative Example 1-2

A solid electrolyte composition of Comparative Example 1-2 was produced in the same manner as in Example 1-1 except that a solution-polymerized styrene-butadiene rubber (modified SBR, manufactured by Asahi Kasei Corporation, Tufdene 3830) was used as the styrene elastomer. The modified SBR used in Comparative Example 1-2 was produced by washing process oil in the same manner as in Example 1-1. In the modified SBR used in Comparative Example 1-2, the mole fraction of a repeating unit derived from styrene was 0.21.

### Comparative Example 1-3

A solid electrolyte composition of Comparative Example 1-3 was produced in the same manner as in Example 1-1 except that a hydrogenated styrene thermoplastic elastomer (modified SEBS, manufactured by Asahi Kasei Corporation, Tuftec MP10) was used as the styrene elastomer. In the modified SEBS used in Comparative Example 1-3, the mole fraction of a repeating unit derived from styrene was 0.20. “Tuftec” is a registered trademark of Asahi Kasei Corporation.

### [Measurement of Total Nitrogen Content of Styrene Elastomer]

The total nitrogen content of a styrene elastomer constituting a binder was measured by trace total nitrogen measurement using a total nitrogen microanalyzer (TN-2100H manufactured by Nittoseiko Analytech Co., Ltd. The measurement conditions are described below.

### [Measurement Conditions]

Temperature of pyrolysis furnace: 800° C.
Temperature of oxidation furnace: 900° C.
Carrier gas: O₂ and Ar
Standard sample: pyridine/toluene solution
Detector: reduced-pressure chemiluminescence detector

Under these measurement conditions, the mass (μg) of nitrogen (N) contained in 1 g of polymer was measured to calculate the total nitrogen content from the ratio (μg/g=ppm).

### [Measurement of Weight-Average Molecular Weight]

The weight-average molecular weight of a styrene elastomer constituting a binder was measured by gel permeation chromatograph (GPC) measurement using a high performance GPC apparatus (HLC-832-GPC manufactured by Tosoh Corporation). A measurement sample was a styrene elastomer dissolved in chloroform and filtered through a filter with a pore size of 0.2 μm. Two Super HM-H columns manufactured by Tosoh Corporation were used. For the GPC measurement, a differential refractometer (RI) was used. The GPC measurement was performed at a flow velocity of 0.6 mL/min and at a column temperature of 40° C. A monodisperse polystyrene (manufactured by Tosoh Corporation) was used as a standard sample. The weight-average molecular weight (M_{w}) of a styrene elastomer was measured by GPC measurement.

[Measurement of Nitrogen Ratio with respect to Polymer Chain]

For the styrene elastomers used in Example 1-1, Example 1-2, and Comparative Example 1-1 to Comparative Example 1-3, the nitrogen ratio with respect to a polymer chain was calculated using the following formula (i) on the basis of the weight-average molecular weight (M_{w}, unit: g/mol) and the total nitrogen content (n, unit: ppm) determined by the measurements.

$$Nitrogen ratio with respect to polymer chain = {M}_{w} \times n / 14 , 000 , 000 \qquad formula ( i )$$

### [Measurement of Pulsed NMR]

The solid electrolyte compositions of Example 1-1, Example 1-2, and Comparative Example 1-1 to Comparative Example 1-3 were subjected to pulsed NMR measurement by the following method.

In an argon glove box with a dew point of −60° C. or less, a solid electrolyte composition was added to a glass tube with a diameter of 10 mm, and the sample was then sealed with a cap for the glass tube. The glass tube containing the sample was then taken out of the argon glove box, and a relaxation curve was obtained using a pulsed NMR apparatus (minispec mq20 manufactured by Bruker AXS K.K.). The measurement conditions are described below.

### [Measurement Conditions]

Nucleus observed: hydrogen (¹H)
Relaxation time to be measured: transverse relaxation time T₂
Pulse sequence: CPMG method
Pulse interval [90 degrees to 180 degrees]: 1 ms
Measurement temperature: 25° C.

The resulting relaxation curve was separated into two components and was analyzed. The faster relaxation component was defined as a component 1 and the slower relaxation component was defined as a component 2. The transverse relaxation time T₂ [ms] and ratio [%] of each component were determined.

### [Measurement of Peel Strength]

For the solid electrolyte compositions of Example 1-1, Example 1-2, and Comparative Example 1-1 to Comparative Example 1-3, solid electrolyte sheets were produced to measure peel strength by the following method.

In an argon glove box with a dew point of −60° C. or less, the solid electrolyte composition was applied to an aluminum alloy foil coated with electrically conductive carbon using a four-sided applicator with a gap of 100 μm to form a coating film. The coating film was dried in a vacuum at 100° C. for 1 hour to produce a solid electrolyte sheet. The peel strength of the solid electrolyte sheet was measured. The peel strength was measured in a dry room with a dew point of −50° C. or less by the following method using a universal testing machine (RTH-1310 manufactured by A&D Company, Limited). First, the solid electrolyte sheet cut in a width of 15 mm and a test sheet were bonded to each other with a double-sided tape. More specifically, the solid electrolyte sheet was bonded to the test sheet via the double-sided tape. The solid electrolyte sheet was then peeled from the base material at a peel angle of 90 degrees and at a peel rate of 5 mm/min using a testing machine in which an adhesive tape 90-degree peeling test jig was set. After the measurement was started, the value measured for the first 2-mm peeling from the base material was not used, and the measured value (unit: N) continuously recorded for the 10-mm solid electrolyte sheet peeled off from the base material was then recorded. A value obtained by dividing the average value of the measured values by the width of the solid electrolyte sheet was regarded as the peel strength (unit: N/m) between the solid electrolyte sheet and the base material.

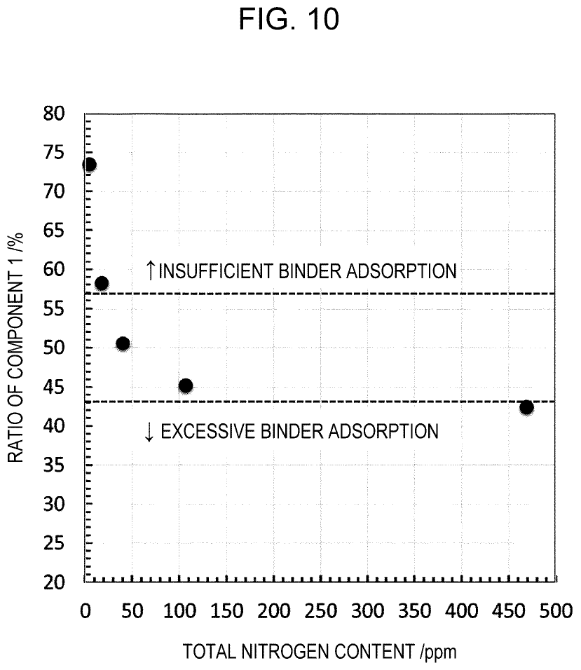

Table 1 and FIG. 10 show the measurement results. Binder types A to E in Table 1 correspond to the following polymers.
A: solution-polymerized styrene-butadiene rubber (modified SBR), Tufdene E680
B: solution-polymerized styrene-butadiene rubber (modified SBR), Asaprene Y031
C: solution-polymerized styrene-butadiene rubber (SBR), Tufdene 2100R
D: solution-polymerized styrene-butadiene rubber (modified SBR), Tufdene 3830
E: hydrogenated styrene thermoplastic elastomer (modified SEBS), Tuftec MP10

TABLE 1

| | Binder in solid electrolyte composition | | | | | | | |
|---|---|---|---|---|---|---|---|---|
| | | | Weight- | | Pulsed NMR measurement of | | | Peel |
| | | Total | average | Nitrogen | solid electrolyte composition | | | strength of |
| | | nitrogen | molecular | ratio to | T₂ of | Ratio of | T₂ of | solid |
| | Type of | content | weight | polymer | component | component | component | electrolyte |
| | binder | [ppm] | [M_{w}] | chain | 1 [ms] | 1 [%] | 2 [ms] | sheet [N/m] |
| Example 1-1 | A | 40 | 1,130,000 | 3.2 | 269 | 50.6 | 403 | 20.1 |
| Example 1-2 | B | 107 | 380,000 | 2.9 | 276 | 45.3 | 424 | 14.7 |
| Comparative | C | 4.4 | 390,000 | 0.12 | 324 | 73.5 | 404 | 11.1 |
| Example 1-1 | | | | | | | | |
| Comparative | D | 17 | 890,000 | 1.1 | 291 | 58.3 | 403 | 16.3 |
| Example 1-2 | | | | | | | | |
| Comparative | E | 469 | 58,000 | 1.9 | 260 | 42.5 | 408 | 13.2 |
| Example 1-3 | | | | | | | | |

FIG. 10 is a graph of the ratio of the component 1 determined by pulsed NMR measurement to the total nitrogen content of a styrene elastomer in Examples and Comparative Examples. In the graph of FIG. 10, the vertical axis represents the ratio [%] of the component 1 determined by the pulsed NMR measurement, and the horizontal axis represents the total nitrogen content [ppm] of the styrene elastomer. In FIG. 10, broken lines parallel to the horizontal axis indicate a straight line in which the ratio of the component 1 is 43% and a straight line in which the ratio of the component 1 is 57%.

Each of the solid electrolyte compositions of Example 1-1, Example 1-2, and Comparative Example 1-1 to Comparative Example 1-3 contains a styrene elastomer as a binder. Table 1 and FIG. 10 show that the ratio of the component 1 in the pulsed NMR measurement was 50.6% in Example 1-1 and 45.3% in Example 1-2. In the solid electrolyte compositions of Example 1-1 and Example 1-2, the ratio of the component 1 was close to 50%, indicating high dispersibility of the solid electrolyte. In Comparative Example 1-1 and Comparative Example 1-2, the total nitrogen content of the styrene elastomer in the solid electrolyte composition is too low. Thus, in Comparative Example 1-1 and Comparative Example 1-2, it is presumed that the binder was insufficiently adsorbed to the solid electrolyte, and the solid electrolyte was poorly dispersed. In Comparative Example 1-3, the total nitrogen content of the styrene elastomer is too high. Thus, in Comparative Example 1-3, it is presumed that the binder was excessively adsorbed to the solid electrolyte, and the solid electrolyte was poorly dispersed. In Comparative Example 1-3, a styrene elastomer with a low molecular weight was used to increase the total nitrogen content of the styrene elastomer. Consequently, it is surmised that the solid electrolyte sheet produced using the solid electrolyte composition of Comparative Example 1-3 had a lower peel strength than the solid electrolyte sheets produced using the solid electrolyte compositions of Example 1-1 and Example 1-2.

As shown in Table 1, in the solid electrolyte compositions of Examples in which the styrene elastomer with a nitrogen content of 30 ppm or more and 130 ppm or less was used as a binder, the dispersibility of the solid electrolyte could be improved.

A solid electrolyte composition according to the present disclosure can be used, for example, to produce an all-solid-state lithium-ion secondary battery.

What is claimed is:

1. A solid electrolyte composition comprising:
a solvent; and
an ionic conductor containing a solid electrolyte and a binder and dispersed in the solvent,
wherein the binder contains a styrene elastomer, and
the styrene elastomer has a total nitrogen content of 30 ppm or more and 130 ppm or less.

2. The solid electrolyte composition according to claim 1, wherein the styrene elastomer has a weight-average molecular weight of 200,000 or more.

3. The solid electrolyte composition according to claim 1, wherein a nitrogen ratio with respect to a polymer chain of the styrene elastomer is 2.0 or more.

4. The solid electrolyte composition according to claim 1, wherein the styrene elastomer includes at least one selected from the group consisting of a modified SEBS and a modified SBR.

5. The solid electrolyte composition according to claim 4, wherein the styrene elastomer includes a modified SBR.

6. The solid electrolyte composition according to claim 1, wherein the solvent has a boiling point of 100° C. or more and 250° C. or less.

7. The solid electrolyte composition according to claim 1, wherein the solvent contains an aromatic hydrocarbon.

8. The solid electrolyte composition according to claim 7, wherein the solvent contains tetralin.

9. The solid electrolyte composition according to claim 1, wherein the solid electrolyte includes a sulfide solid electrolyte.

10. The solid electrolyte composition according to claim 1, wherein the solid electrolyte includes a halide solid electrolyte.

11. An electrode composition comprising:
an active material; and
the solid electrolyte composition according to claim 1.

12. A method for producing a solid electrolyte sheet, comprising:
applying the solid electrolyte composition according to claim 1 to an electrode or a base material to form a coating film; and
removing the solvent from the coating film.

13. A method for producing a battery including a first electrode, an electrolyte layer, and a second electrode in this order, the method comprising the following (i) or (ii):
(i) applying the solid electrolyte composition according to claim 1 to the first electrode to form a coating film,
removing the solvent from the coating film to form an electrode assembly including the first electrode and the electrolyte layer, and
combining the electrode assembly and the second electrode such that the electrolyte layer is positioned between the first electrode and the second electrode, or
(ii) applying the solid electrolyte composition according to claim 1 to a base material to form a coating film,
removing the solvent from the coating film to form the electrolyte layer, and
combining the first electrode, the second electrode, and the electrolyte layer such that the electrolyte layer is positioned between the first electrode and the second electrode.

14. A method for producing an electrode sheet, comprising:
applying the electrode composition according to claim 11 to a current collector, a base material, or an electrode assembly to form a coating film; and
removing the solvent from the coating film.

15. A method for producing a battery including a first electrode, an electrolyte layer, and a second electrode in this order, the method comprising the following (iii), (iv), or (v):
(iii) applying the electrode composition according to claim 11 to a current collector to form a coating film,
removing the solvent from the coating film to form the first electrode, and
combining the first electrode, the second electrode, and the electrolyte layer such that the electrolyte layer is positioned between the first electrode and the second electrode,
(iv) applying the electrode composition according to claim 11 to a base material to form a coating film,
removing the solvent from the coating film to form an electrode sheet for the first electrode, and
combining the first electrode, the second electrode, and the electrolyte layer such that the electrolyte layer is positioned between the first electrode and the second electrode, or
(v) applying the electrode composition according to claim 11 to the electrolyte layer of an electrode assembly, which is a laminate of the first electrode and the electrolyte layer, to form a coating film, and
removing the solvent from the coating film to form an electrode sheet for the second electrode.

16. A method for producing a battery including a first electrode, an electrolyte layer, and a second electrode in this order, the method comprising (vi) or (vii):
(vi) applying the electrode composition including an active material and
the solid electrolyte composition according to claim 1 to a current collector to form a first coating film,
removing the solvent from the first coating film to form the first electrode,
applying the solid electrolyte composition according to claim 1 to the first electrode to form a second coating film,
removing the solvent from the second coating film to form the electrolyte layer, and
combining the first electrode, the electrolyte layer, and the second electrode such that the electrolyte layer is positioned between the first electrode and the second electrode, or
(vii) applying the electrode composition including an active material and
the solid electrolyte composition according to claim 1 to a first base material to form a first coating film,
removing the solvent from the first coating film to form the first electrode,
applying the solid electrolyte composition according to claim 1 to a second base material to form a second coating film,
removing the solvent from the second coating film to form the electrolyte layer, and combining the first electrode, the second electrode, and
the electrolyte layer such that the electrolyte layer is positioned between the first electrode and the second electrode.
